(19) United States
(12) Patent Application Publication
(10) Pub. No.: US 2010/0308111 A1
(43) Pub. Date: Dec. 9, 2010

(54) SYSTEMS AND METHODS FOR TRACKING LITIGATION HOLD MATERIALS

(75) Inventors: Eric J. Scharf, Arlington, VA (US); James A. Friedman, West Hartford, CT (US); James G. Schlett, Reston, VA (US); Robert P. Sindermann, JR., Arlington, VA (US)

Correspondence Address: KNOBBE MARTENS OLSON & BEAR LLP, 2040 MAIN STREET, FOURTEENTH FLOOR, IRVINE, CA, 92614, US

(73) Assignee: United States Postal Service, Washington, DC (US)

(21) Appl. No.: 12/481,529

(22) Filed: Jun. 9, 2009

(51) Int. Cl. G06F 19/00

(52) U.S. Cl. 235/385

(57) ABSTRACT

Embodiments include systems and methods for tracking litigation hold materials. In one embodiment, a litigation hold system is used to track an organization's progress in preserving materials relevant to a litigation matter. In one embodiment, the litigation hold system provides an automated system for sending litigation hold notices and tracking individuals' responses to the received litigation hold notice. The litigation hold system may further automatically send reminder notices to remind an individual of his continuing obligation to comply. The litigation hold system may automate the process of sending release notices once the obligation to preserve materials for the litigation has ended.

### BACKGROUND OF THE INVENTION

1. Field of the Invention

Embodiments relate to systems and methods for tracking litigation hold materials.

2. Description of the Related Art

There is an obligation to preserve relevant documents during litigation. An organization may issue a “litigation hold” to preserve documents relevant to the litigation. In a large organization, there may be many custodians of relevant documents. Thus, the process of notifying all potential custodians of relevant materials as well as the process of tracking the custodians' actions to preserve the relevant materials is a cumbersome process. Hence, improved methods and systems for tracking litigation hold materials are desirable.

### SUMMARY OF THE INVENTION

The systems, methods, and devices of the development each have several aspects, no single one of which is solely responsible for its desirable attributes. Without limiting the scope of the development as expressed by the claims which follow, its more prominent features will now be discussed briefly. After considering this discussion, and particularly after reading the section entitled “Detailed Description of Certain Embodiments” one will understand how the features of the development provide advantages that include greater efficiency for tracking materials relevant to a litigation matter.

In one embodiment, a method of tracking materials preserved for a litigation comprises providing a user interface for receiving a description of materials that should be preserved for a litigation and data identifying at least one recipient of an electronic notice regarding the litigation, generating a user interface for requesting information from the recipient, wherein the requested information comprises: a certification that the recipient is in possession of materials that should be preserved for the litigation, a description of the recipient's procedures for preserving the materials that should be preserved for the litigation, and a list of other entities identified by the recipient as associated with materials to be preserved for the litigation, receiving via a network a response from the recipient, storing the response, and logging information about communications with the recipient.

In another embodiment, a method of tracking materials preserved for litigation comprises generating a first electronic notice comprising a description of materials that should be preserved for a litigation and a request to preserve the materials described, sending the first notice to a recipient via the a network, receiving a response to the notice from the recipient via the network, generating a second notice informing the recipient of the first notice that the materials described in the first notice no longer need to be preserved for the litigation, and sending the second notice to the recipient via the network.

In another embodiment, a system for tracking materials preserved for a litigation comprises a storage medium configured to store information regarding communications with a recipient of an electronic notice and at least one processor configured to: provide a user interface for receiving a description of materials that should be preserved for a litigation and data identifying at least one recipient of an electronic notice regarding the litigation, generate a user interface for requesting information from the recipient, wherein the requested information comprises: a certification that the recipient is in possession of materials that should be preserved for the litigation, a description of the recipient's procedures for preserving the materials that should be preserved for the litigation, and a list of other entities identified by the recipient as associated with materials to be preserved for the litigation, receive via a network a response from the recipient, store the response, and log information about communications with the recipient.

In another embodiment, a system of tracking materials preserved for litigation comprises a storage medium configured to store information about communications with a recipient of an electronic notice and at least one processor configured to: generate a first electronic notice comprising a description of materials that should be preserved for a litigation and a request to preserve the materials described, send the first notice to a recipient via a network, receive a response to the notice from the recipient via the network, generate a second notice informing the recipient of the first notice that the materials described in the first notice no longer need to be preserved for the litigation, and send the second notice to the recipient via the network.

In another embodiment, a system for tracking materials preserved for a litigation comprises means for providing a user interface for receiving a description of materials that should be preserved for a litigation and data identifying at least one recipient of an electronic notice regarding the litigation, means for generating a user interface for requesting information from the recipient, wherein the requested information comprises a certification that the recipient is in possession of materials that should be preserved for the litigation, a description of the recipient's procedures for preserving the materials that should be preserved for the litigation, and a list of other entities identified by the recipient as associated with materials to be preserved for the litigation, means for receiving via a network a response from the recipient, means for storing the response, and means for logging information about communications with the recipient.

In another embodiment, a system of tracking materials preserved for litigation comprises means for generating a first electronic notice comprising a description of materials that should be preserved for a litigation and a request to preserve the materials described, means for sending the first notice to a recipient via a network, means for receiving a response to the notice from the recipient via the network, means for generating a second notice informing the recipient of the first notice that the materials described in the first notice no longer need to be preserved for the litigation, and means for sending the second notice to the recipient via the network.

### BRIEF DESCRIPTION OF THE DRAWINGS

FIG. 1 is a block diagram illustrating one embodiment of a litigation hold system.

FIG. 2 is a screenshot illustrating one embodiment of a tracking interface for tracking litigation hold materials.

FIG. 3 is a flow diagram illustrating one embodiment of a method for tracking litigation hold materials.

FIG. 4 is a screenshot illustrating one embodiment of a recipient input interface 401 for receiving a list of recipients of a litigation hold notice.

FIG. 5 is a screenshot illustrating one embodiment of a recipient input interface for receiving a list of recipients of a litigation hold notice.

FIG. 6 is a screenshot illustrating one embodiment of a recipient input interface for receiving a list of recipients of a litigation hold notice.

FIG. 7 is a screenshot illustrating one embodiment of a recipient input interface for receiving a list of recipients of a litigation hold notice.

FIG. 8 is a screenshot illustrating one embodiment of a recipient input interface for receiving a list of recipients of a litigation hold notice.

FIG. 9 is a screenshot illustrating one embodiment of a recipient input interface for receiving a list of recipients of a litigation hold notice.

FIG. 10 is a screenshot illustrating one embodiment of a recipient input interface for receiving a list of recipients of a litigation hold notice.

FIG. 11 is a screenshot illustrating one embodiment of a recipient input interface for receiving a list of recipients of a litigation hold notice.

FIG. 12 is a screenshot illustrating one embodiment of an interface for receiving a list of outside recipients of a litigation hold notice.

FIG. 13 is a screenshot illustrating one embodiment of an interface for receiving a list of outside recipients of a litigation hold notice.

FIG. 14 is a screenshot illustrating one embodiment of an interface for receiving a list of outside recipients of a litigation hold notice.

FIG. 15 is a screenshot illustrating one embodiment of a recipient input interface for receiving a list of recipients of a litigation hold notice.

FIG. 16 is a screenshot illustrating one embodiment of a recipient input interface for receiving a list of recipients of a litigation hold notice.

FIG. 17 is a screenshot illustrating one embodiment of a litigation hold notice input interface for describing the litigation hold obligation.

FIG. 18 is a screenshot illustrating one embodiment of a litigation hold notice input interface for describing the litigation hold obligation.

FIG. 19 is a screenshot illustrating one embodiment of a litigation hold notice input interface for describing the litigation hold obligation.

FIG. 20 is a screenshot illustrating one embodiment of a litigation hold notice input interface for describing the litigation hold obligation.

FIG. 21 is a screenshot illustrating one embodiment a sample litigation hold notice.

FIG. 22 is a screenshot illustrating one embodiment a sample litigation hold notice.

FIG. 23 is a screenshot illustrating one embodiment of an updated litigation hold notice input interface.

FIG. 24 is a screenshot illustrating one embodiment of an updated litigation hold notice input interface.

FIG. 25 is a screenshot illustrating one embodiment of a draft notification email.

FIG. 26 is a screenshot illustrating one embodiment of a notification of a draft of a litigation hold notice.

FIG. 27a is a screenshot illustrating one embodiment of an interface displaying a saved draft of a litigation hold notice.

FIG. 27b is a screenshot illustrating one embodiment of an interface displaying a saved draft of a litigation hold notice.

FIG. 28a is a screenshot illustrating one embodiment of a litigation hold notice interface.

FIG. 28b is a screenshot illustrating one embodiment of a litigation hold notice interface.

FIG. 29 is a screenshot illustrating one embodiment of a disclosure and preservation interface.

FIG. 30a is a screenshot illustrating one embodiment of a disclosure and preservation interface.

FIG. 30b is a screenshot illustrating one embodiment of a disclosure and preservation interface.

FIG. 30c is a screenshot illustrating one embodiment of a disclosure and preservation interface.

FIG. 31a is a screenshot illustrating one embodiment of a preservation and disclosure interface for a recipient outside of an organization.

FIG. 31b is a screenshot illustrating one embodiment of a preservation and disclosure interface for a recipient outside of an organization.

FIG. 32a is a screenshot illustrating one embodiment of a preservation and disclosure email response.

FIG. 32b is a screenshot illustrating one embodiment of a preservation and disclosure email response.

FIG. 33 is a screenshot illustrating one embodiment of a follow up message to the recipient's response to the preservation and disclosure interface.

FIG. 34a is a screenshot illustrating one embodiment of a response receipt displaying a recipient's responses to a preservation and disclosure interface.

FIG. 34b is a screenshot illustrating one embodiment of a response receipt displaying a recipient's responses to a preservation and disclosure interface.

FIG. 35 is a screenshot illustrating one embodiment of a response receipt displaying a recipient's responses to a preservation and disclosure interface.

FIG. 36 is a screenshot illustrating one embodiment of a report interface.

FIG. 37 is a screenshot illustrating one embodiment of a report interface.

FIG. 38 is a screenshot illustrating one embodiment of a report interface.

FIG. 39a is a screenshot illustrating one embodiment of a recipient input interface combined with a litigation hold notice input interface.

FIG. 39b is a screenshot illustrating one embodiment of a recipient input interface combined with a litigation hold notice input interface.

FIG. 40 is a screenshot illustrating one embodiment of a reminder notice input interface.

FIG. 41a is a screenshot illustrating one embodiment of a sample litigation hold reminder notice.

FIG. 41b is a screenshot illustrating one embodiment of a sample litigation hold reminder notice.

FIG. 42a is a screenshot illustrating one embodiment of a reminder hold notice.

FIG. 42b is a screenshot illustrating one embodiment of a reminder hold notice.

FIG. 43 is a screenshot illustrating one embodiment of a report interface.

FIG. 44 is a flow diagram illustrating one embodiment of a method for tracking a litigation hold notice.

FIG. 45 is a screenshot illustrating one embodiment of a release notice input interface.

FIG. 46 is a screenshot illustrating one embodiment of a sample release notice interface.

FIG. 47 is a screenshot illustrating one embodiment of a litigation hold release notice.

FIG. 48 is a flow diagram illustrating one embodiment of a method for tracking a litigation hold notice.

### DETAILED DESCRIPTION OF THE PREFERRED EMBODIMENT

The following detailed description is directed to certain specific embodiments of the development. However, the development can be embodied in a multitude of different ways as defined and covered by the claims. In this description, reference is made to the drawings wherein like parts are designated with like numerals throughout.

In some cases there is an obligation to preserve materials relevant to a litigation matter. An organization may institute a litigation hold policy to preserve materials potentially relevant to the litigation matter. In a large organization notifying employees to preserve relevant materials and tracking an individual's compliance in preserving materials is a cumbersome task. In an organization involved in multiple litigations, the task becomes even more unmanageable.

In one embodiment, a litigation hold system is used to track an organization's progress in preserving materials relevant to a litigation matter. The litigation hold system provides many important benefits, including providing a more efficient and thorough method for preserving materials for litigation. For example, the litigation hold system may provide an automated system for sending litigation hold notices and tracking individuals' responses to the received litigation hold notice. The litigation system may further automate sending reminder notices to remind an individual of his continuing obligation to comply. The litigation system may automate sending release notices once the obligation to preserve materials for the litigation has ended. The litigation hold system could be used in a wide variety of settings. The litigation hold system could be used, for example, by a commercial or a public entity, such as the Law Department of the United States Postal Service (“USPS”).

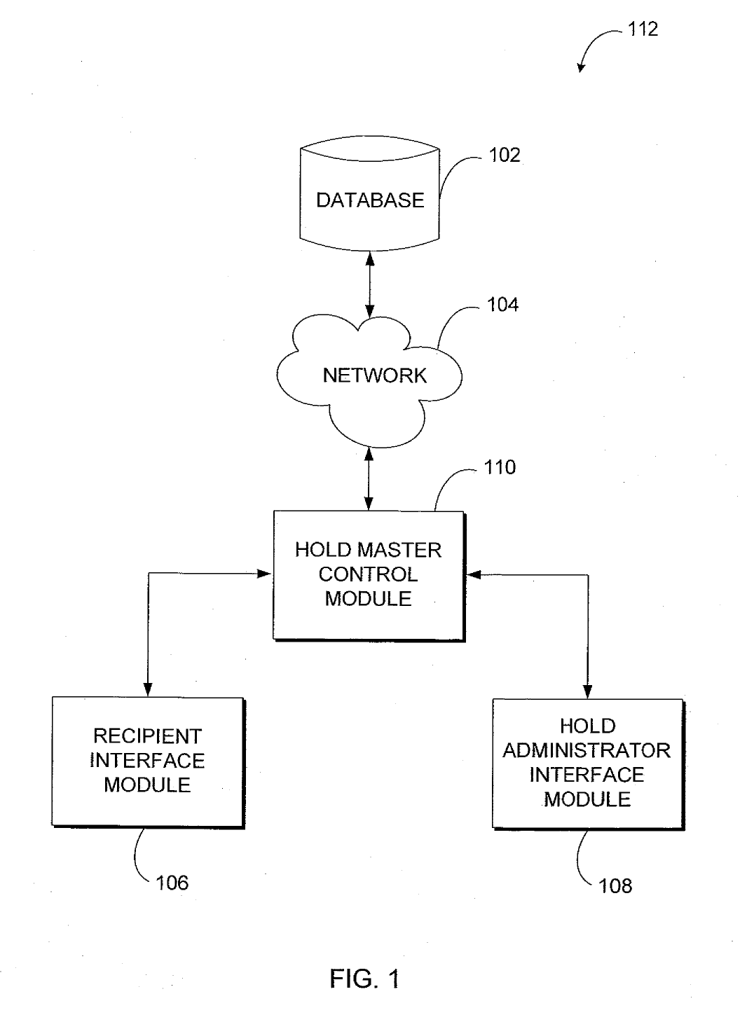

FIG. 1 is a block diagram illustrating one embodiment of a litigation hold system 112. The litigation hold system 112 includes a database 102, a network 104, a hold master control module 110, a recipient interface module 106, and a hold administrator interface module 108. The database 102 is connected via the network 104 to the hold master control module 110. In one embodiment, the network 104 includes one or more private or public data networks such as the Internet. The hold master control module 110 is electrically connected to both the recipient interface module 106 and the hold administrator interface module 108.

In one embodiment, the hold master control module 110 is a web server. In another embodiment, the hold master control module 110 is an email server. The hold master control module 110 sends data to the database 102 and retrieves data from the database 102. One skilled in the art will recognize that the databases discussed herein may be in any suitable format. For example, the database 102 may be a relational database.

In one embodiment, the hold administrator interface module 108 generates interfaces for creating, managing, and reporting litigation hold notices and response forms. In one embodiment, the hold administrator interface module 108 may generate an interface with a template litigation hold notice. An administrator may then update the template and save the litigation hold notice. An administrator may be, for example, an attorney, paralegal, or administrative assistant. In one embodiment, the hold administrator interface module 108 generates an interface that allows an administrator to select recipients of the litigation hold notice. In one embodiment, the hold administrator interface module 108 generates an interface that allows an administrator to customize a preservation and disclosure form to be completed by a recipient of a litigation hold notice. In one embodiment, the hold administrator interface module 108 also generates a report interface that displays communications with the recipients of the litigation hold notice.

The interfaces generated by the hold administrator interface module 108 may display information stored in the database 102. For example, the list of recipients and information regarding the litigation hold notice and preservation and disclosure form may be stored in the database 102. In one embodiment, the hold master control module 110 transmits the litigation hold notice to the selected recipients. The recipient interface module 106 then generates an interface displaying the litigation hold notice as designed through the hold administrator interface module 108. In another embodiment, the recipient interface module 106 generates a preservation and disclosure interface for receiving information about a litigation hold notice recipient's compliance with the litigation hold notice. Information regarding a recipient's response to the preservation and disclosure interface may be saved in the database 102. In one embodiment, the hold administrator interface module 108 generates a reporting interface that displays information pertaining to the recipients of a litigation hold notice and the recipients' responses to the preservation and disclosure interface.

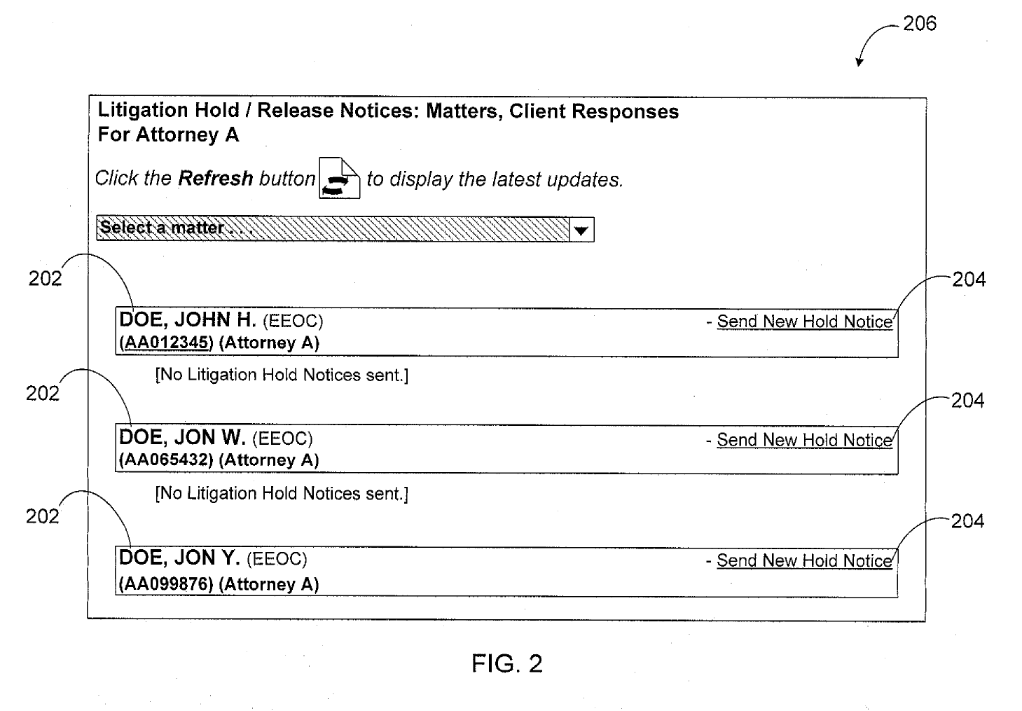

FIG. 2 is a screenshot illustrating one embodiment of a tracking interface 206 for tracking litigation hold materials. The tracking interface 206 may be generated by the hold administrator interface module 108. The tracking interface 206 displays a list of litigation matters 202. A send new hold notice option 204 allows an administrator to create and send a new litigation hold notice for the particular litigation matter 202.

In one embodiment, the litigation hold system 112 is used in conjunction with an independent litigation management system, such as the LawManager® system used by the USPS. For example, the litigation hold system 112 can be used to track a litigation hold notice set for each litigation matter recorded in the litigation management system. In one embodiment, the litigation matters 202 correspond to the litigation matters in the litigation management system. In one embodiment, the litigation matters displayed may be customized to each hold administrator to show only those litigation matters which they are working on or responsible for as noted in the litigation hold system or other database, such as LawManager. Likewise, the litigation matters displayed may be customized to reflect groups, sections, or areas of law for hold administrators or managers of hold administrators.

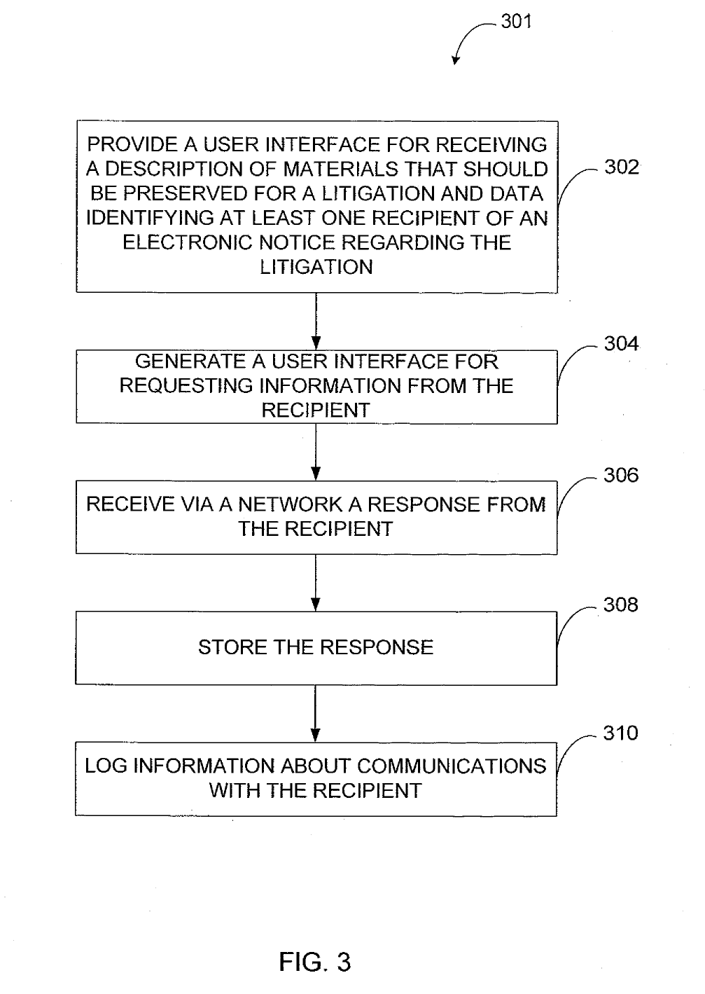

FIG. 3 is a flow diagram illustrating one embodiment of a method 301 for tracking litigation hold materials. Beginning at a block 302, the hold administrator interface module 108 provides a user interface for receiving a description of materials that should be preserved for a litigation and for receiving data identifying at least one recipient of an electronic notice regarding the litigation. The interface provided by the hold administrator interface module 108 allows an administrator to customize the litigation hold notice and the list of recipients. In one embodiment, the interface also allows the administrator to customize a preservation and disclosure form that requests information from the recipient of the litigation hold notice.

In another embodiment, the preservation and disclosure form is the same for all litigation matters, and it may not be customized. The hold master control module 110 then sends a litigation hold notice and a preservation and disclosure form to the recipients selected through the hold administrator interface module 108.

Continuing to a block 304, the recipient interface module 106 generates a user interface for requesting information from the recipient. The requested information may include information describing a recipient's compliance with the litigation hold notice. The requested information may include, for example, a certification that the recipient is in possession of materials that should be preserved for the litigation, a description of the recipient's procedures for preserving the materials that should be preserved for the litigation, and a list of other entities identified by the recipient as associated with materials to be preserved for the litigation. However, the user interface may request any appropriate information and is not limited to the particular information discussed herein. In one embodiment, the recipient interface module 106 generates an email interface so that the recipient emails his response. In another embodiment, the recipient interface module 106 generates a web interface for receiving a recipient's response.

Moving to a block 306, the hold master control module 110 receives via a network a response from the recipient. In one embodiment, the network is the network 104. The response includes the information that the recipient inputted into the interface requesting information generated by the recipient interface module 106. In one embodiment, the hold master control module 110 receives an email with a recipients response. In another embodiment, the hold master control module 110 receives information from a web interface. In one embodiment, the hold master control module 110 receives both an email and a web submission.

Proceeding to a block 308, the hold master control module 110 stores information regarding the response in the database 102. Moving to a block 310, the hold master control module 110 logs information about communications with the recipient. The information about the communications may be stored in the database 102. The hold administrator interface module 108 may generate a reporting interface to display information about communications with the recipient. Each step of the method 301 is described in more detail below as it relates to other figures.

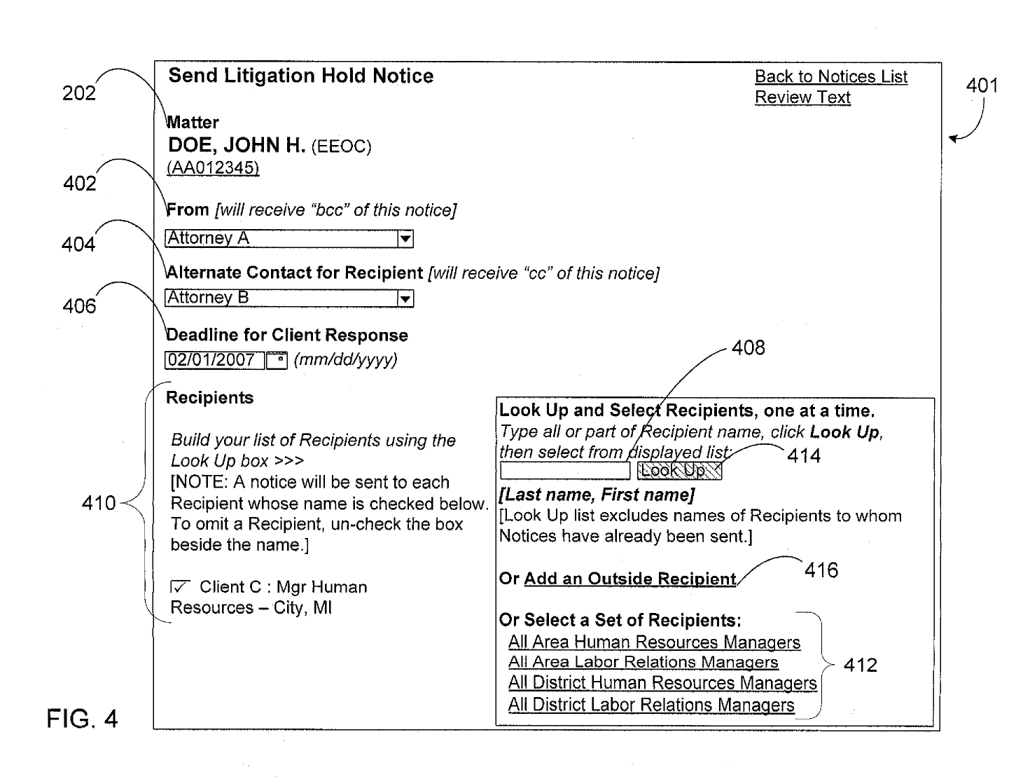

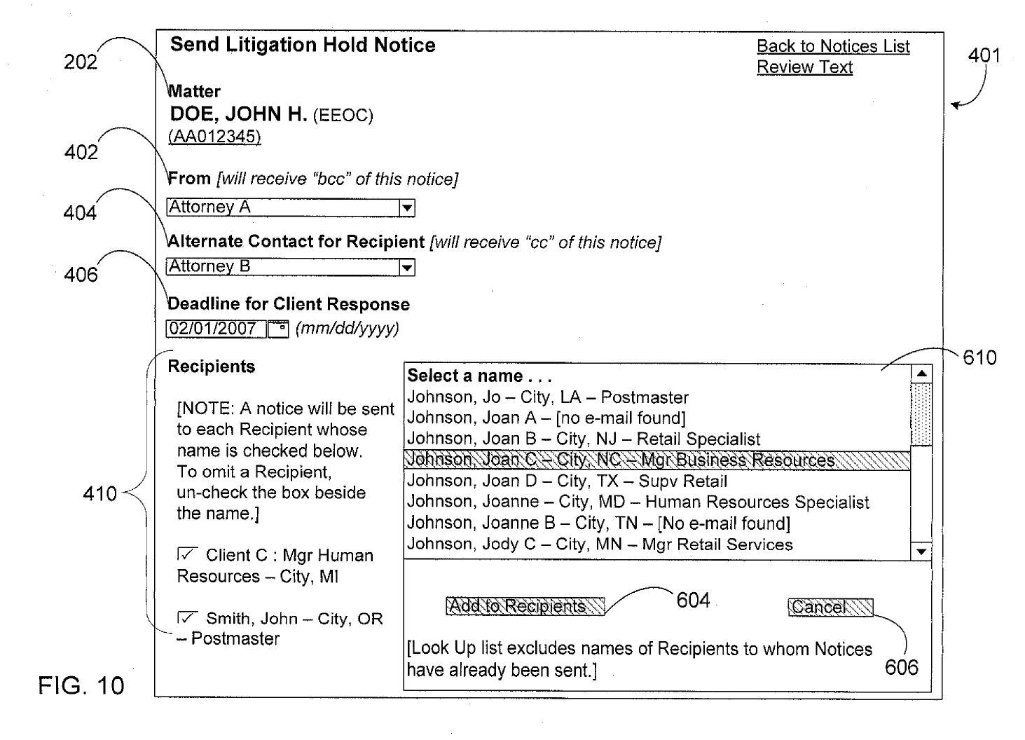

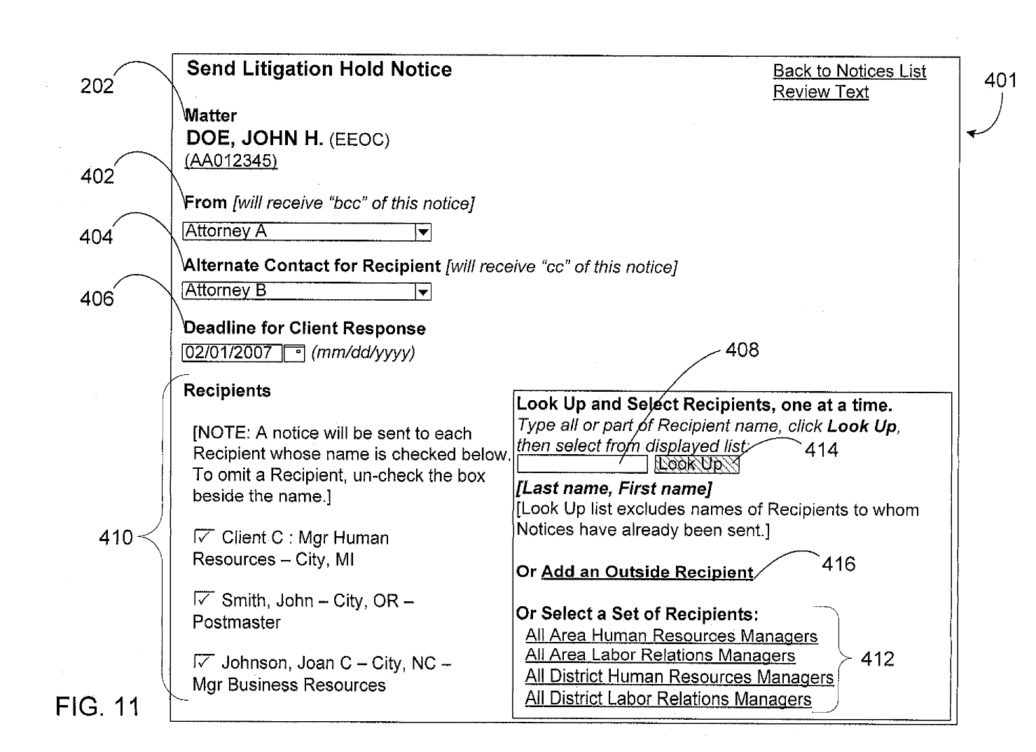

Referring back to the block 302 of the method 301, the hold administrator interface module 108 provides a user interface for receiving a description of materials that should be preserved for a litigation and data identifying at least one recipient of an electronic notice regarding the litigation. FIGS. 4-27b are described as they related to the actions performed at the block 302 of the method 301. In one embodiment, the hold administrator interface module 108 generates an interface that allows an administrator to select recipients of a litigation hold notice. In another embodiment, the hold administrator interface module 108 generates an interface that allows an administrator to select information to display in the litigation hold notice, such as information about the litigation hold obligation. In one embodiment, the information about the litigation hold obligation includes information about the types of materials that should be preserved. In another embodiment, the hold administrator interface module 108 generates a preservation and disclosure interface that allows an administrator to select information to request from the recipient of the litigation hold notice.

In one embodiment, the interfaces initially include default information stored in the database 102, and the administrator may customize the recipients, litigation hold notice, or preservation and disclosure request form through the interface generated by the hold administrator interface module 108. In one embodiment, the interfaces generated by the hold administrator interface module 108 are online web interfaces. The various interfaces generated by the hold administrator interface module 108 are discussed individually below.

FIG. 4 is a screenshot illustrating one embodiment of a recipient input interface 401 for receiving a list of recipients of a litigation hold notice. The recipient input interface 401 may be generated by the hold administrator interface module 108. Information about the litigation matter 202 may be displayed on the recipient input interface 401. In one embodiment, the recipient input interface 401 displays general information regarding the litigation matter.

In one embodiment, the recipient input interface 401 allows an administrator to enter contact information to be displayed in the litigation hold notice. A primary contact field 402 allows an administrator to input a primary contact such as an attorney, paralegal, administrative assistant, or other person. In one embodiment, any email communication with the recipient of the litigation hold notice will appear to be sent from the name entered into the primary contact field 402. An alternate contact field 404 allows an administrator to input an alternate contact such as an attorney or other person. In one embodiment, the litigation hold notice is an email, and the primary contact will receive a blind carbon copy of the email and the alternative contact receives a carbon copy of the email. In one embodiment, the primary and alternate contact information is automatically populated from information stored in the database 102, and the administrator may change the primary and alternate contact if desired. In one embodiment, more than two contacts may be entered into the recipient input interface 401.

A deadline field 406 allows an administrator to enter a deadline for the recipient's response to the litigation hold notice. In one embodiment, the deadline is displayed in the litigation hold notice.

The recipient input interface 401 allows an administrator to select recipients of a litigation hold notice. In one embodiment, a recipient list 410 displays a list of individuals and groups selected to receive the litigation hold notice. In one embodiment, the recipient list 410 allows an administrator to delete a recipient from the recipient list 410, for example, by un-checking a checkbox associated with the particular recipient. In one embodiment, clients and witnesses listed in a litigation management system, such as the LawManager® system used by the USPS, initially appear as the recipients in the recipient list 410. In one embodiment, the recipient list is initially populated with the names of individuals and groups stored in the database 102. The administrator can then add additional recipients to the recipient list 410 or remove recipients from the recipient list 410.

In one embodiment, a recipient field 408 allows an administrator to input a name or a portion of a name of an individual or group. Selecting a recipient lookup option 414 updates the recipient input interface 401 to display possible matches to the name in the recipient field 408. An outside recipient option 416 allows the administrator to add someone who is not a member of the organization to the recipient list 410. Selecting one of the set of recipients options 412 allows an administrator to add groups of individuals to the recipient list 410.

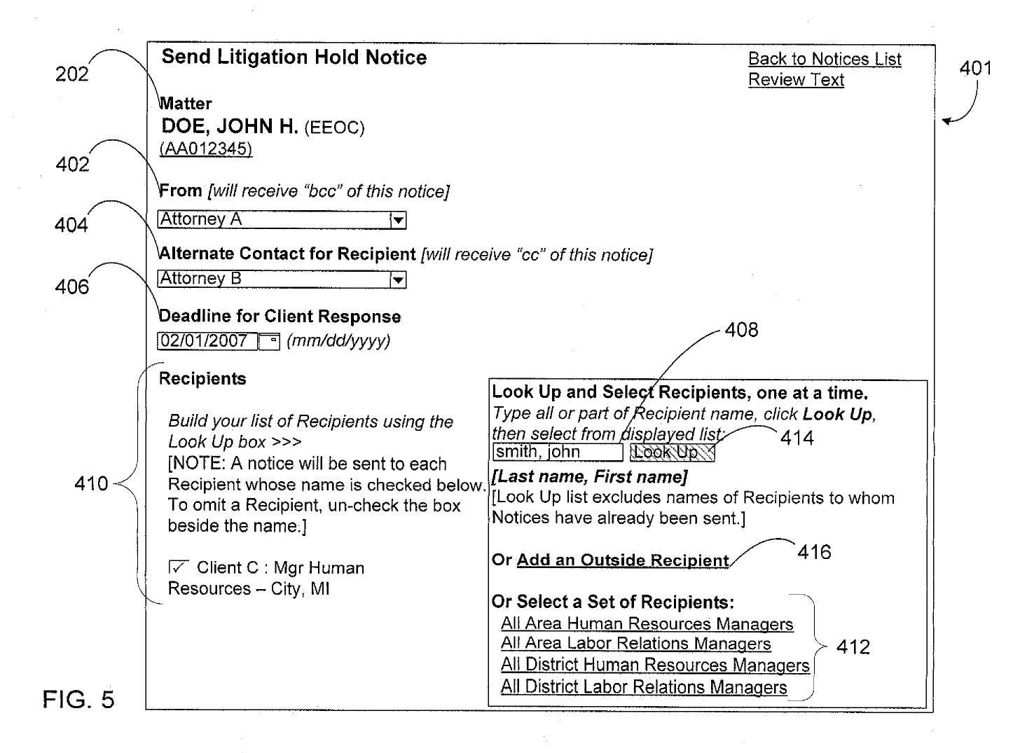

FIGS. 5-8 are screenshots illustrating one embodiment of the recipient input interface 401 for receiving a list of recipients of a litigation hold notice. FIGS. 5-8 illustrate the changes in the recipient input interface 401 when a new recipient is added to the recipient list 410. FIG. 5 illustrates the recipient input interface 401. The recipient field 408 has the name “Smith, John” entered into it. After the name is entered into the recipient field 408, the administrator may select the recipient lookup option 414.

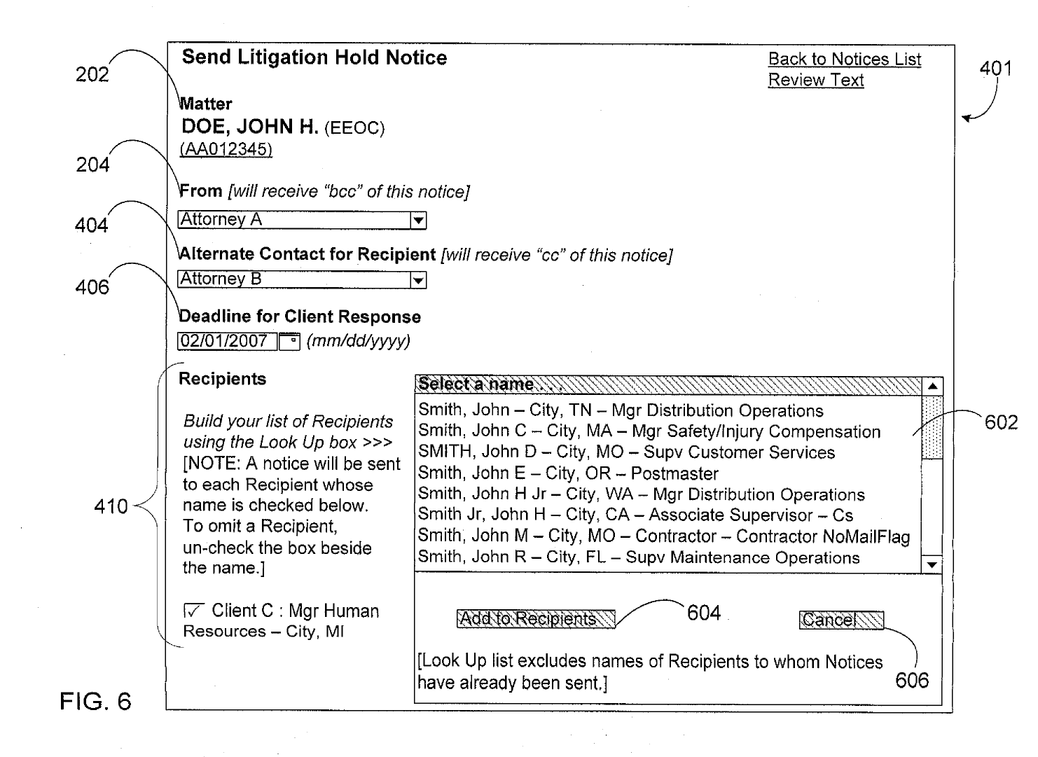

FIG. 6 shows the updated recipient input interface 401 after an administrator selected the recipient look up option 414 to look up the name in the recipient field 408 shown in FIG. 5. The hold administrator interface module 108 updates the recipient input interface 401 to list possible matches for the recipient or group listed in the recipient field 408. A potential recipient list 602 displays the names of individuals and groups in the organization that are possible matches to the text entered into the recipient field 408. In one embodiment, the possible matches are retrieved from the database 102. In another embodiment, the possible recipients are retrieved from the organization's email directory or other database. In one embodiment, the potential recipients in the potential recipient list 602 are from the organization's Active Directory. The administrator then has the option to select one or more individuals or groups displayed in the potential recipient list 602. In FIG. 6, a list of individuals corresponding to “Smith, John” are displayed in the potential recipient list 602, but none of the names have yet been highlighted in the potential recipient list 602.

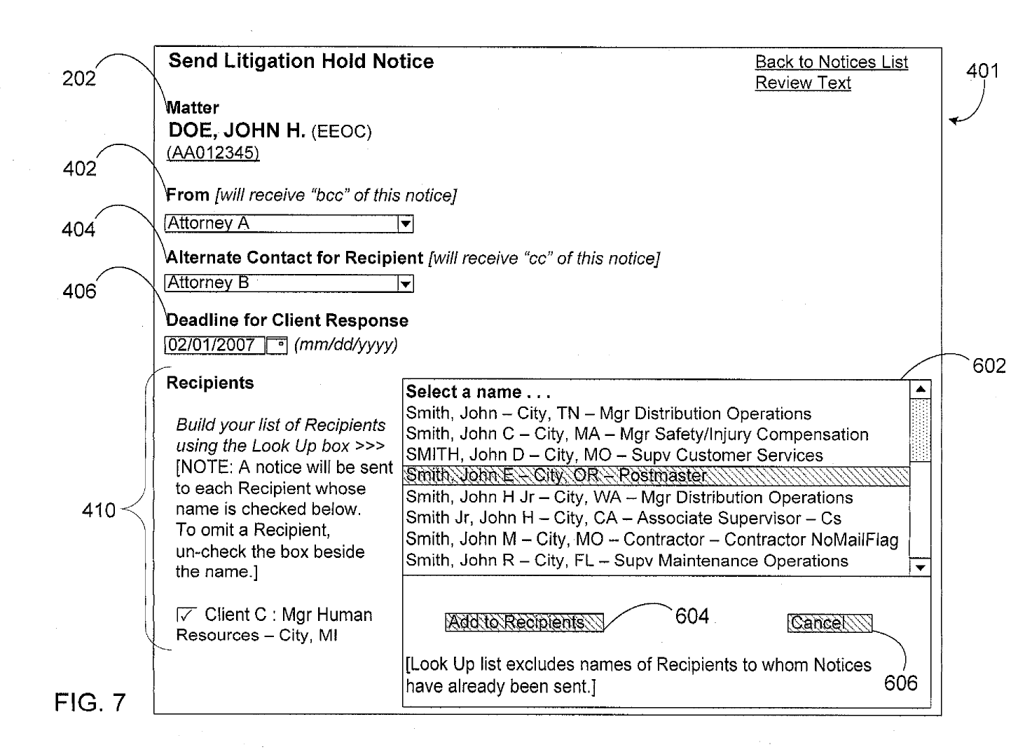

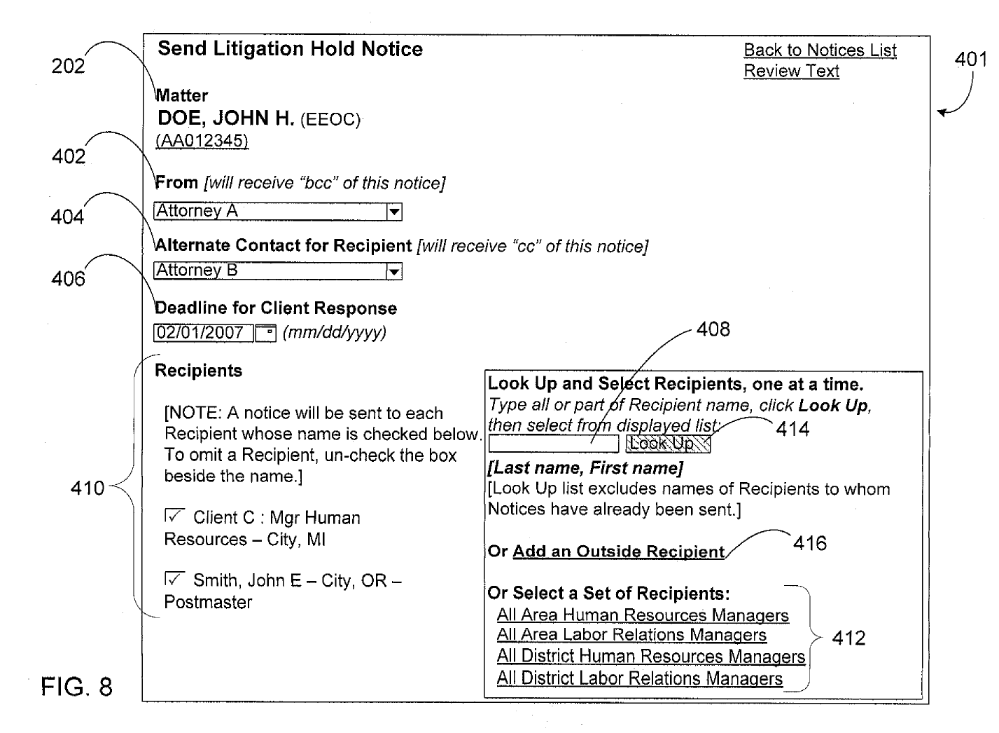

FIG. 7 illustrates the recipient input interface 401 as displayed in FIG. 6. The potential recipient list 602 is highlighted to show an individual selected. In one embodiment, if the administrator selects an add to recipients option 604, the hold administrator interface module 108 updates the interface to show the individuals or groups selected in the potential recipient list 602 added to the recipient list 410. If the administrator instead selects the cancel recipient option 606, no recipients will be added to the recipient list 410. FIG. 8 shows the updated recipient input interface 401 once the individual “Smith, John E” selected in the potential recipient list 602 is added to recipient list 410.

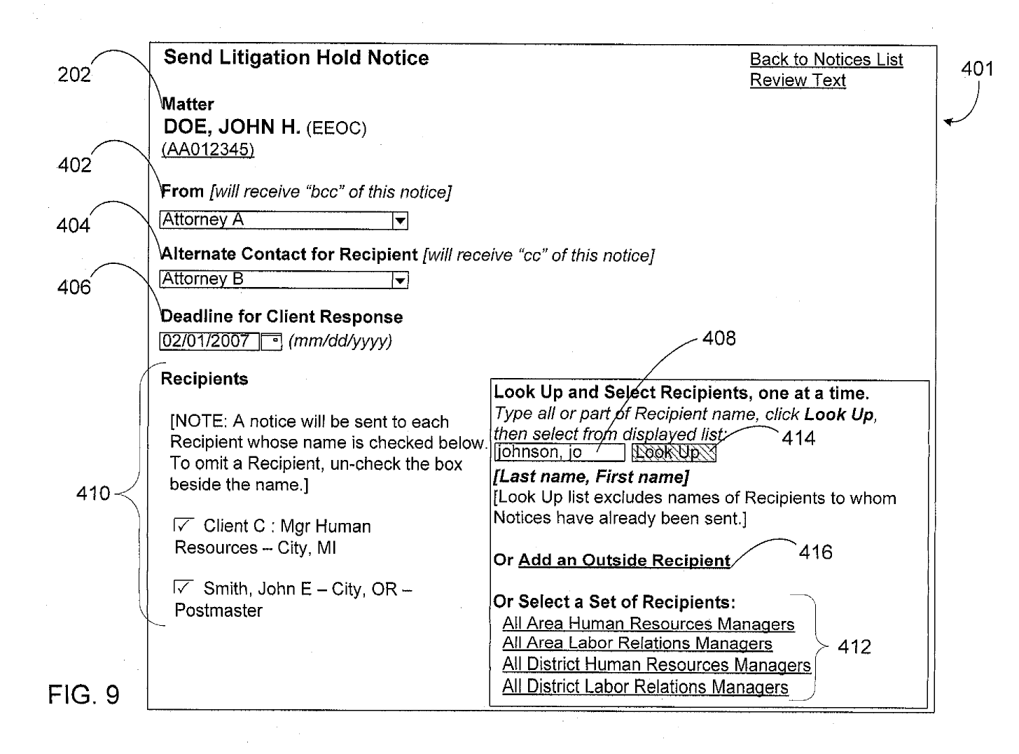

FIGS. 9-11 are screenshots illustrating one embodiment of the recipient input interface 401 for receiving a list of recipients of a litigation hold notice. FIGS. 9-11 show the same process illustrated in FIGS. 5-8 in which a recipient “Johnson, Jo” is added to the recipient list 410.

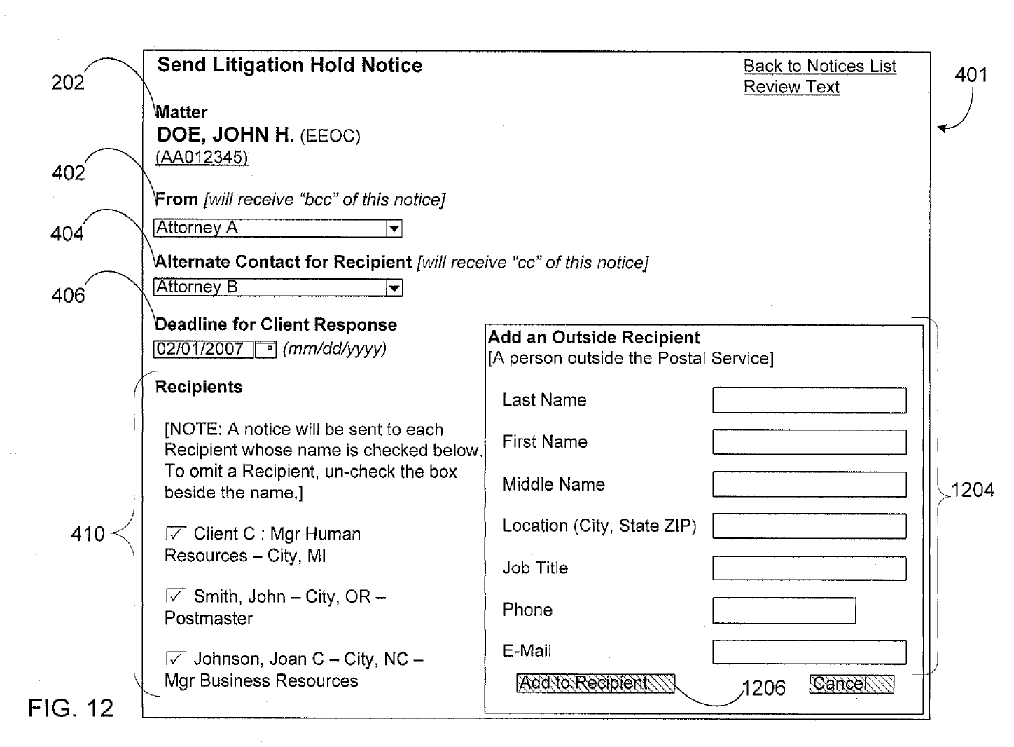

FIGS. 12-14 are screenshots illustrating one embodiment of an interface for receiving a list of outside recipients of a litigation hold notice. In one embodiment, the recipient input interface 401 also allows an administrator to add an individual to the recipient list 401 who is not a member of the organization. For example, an outside recipient may be an independent contractor working with the organization who may have materials relevant to the litigation or a former employee. In one embodiment, information about some outside recipients is stored, such as in the database 102, so that an outside recipient can be added in a manner similar to the manner in which an inside recipient is added as shown in FIGS. 5-11.

In another embodiment, the administrator must add information about the outside recipient to the system. In one embodiment, if an administrator selects the outside recipient option 416, the hold administrator interface module 108 updates the recipient input interface 401 to display fields that allow an administrator to enter information about the outside recipient. The hold administrator interface module 108 then updates the recipient input interface 401 to show the outside recipient added to the recipient list 410.

FIG. 12 illustrates one embodiment of the updated recipient input interface 401 that allows an administrator to enter information regarding an outside recipient. Outside recipient information fields 1204 allow an administrator to enter information about the outside recipient, such as contact information needed in order to send the litigation hold notice. The administrator may then select the add outside recipient option 1206 in order to add the outside recipient to the recipient list 410. In one embodiment, the information about the outside recipient is then stored in the database 102.

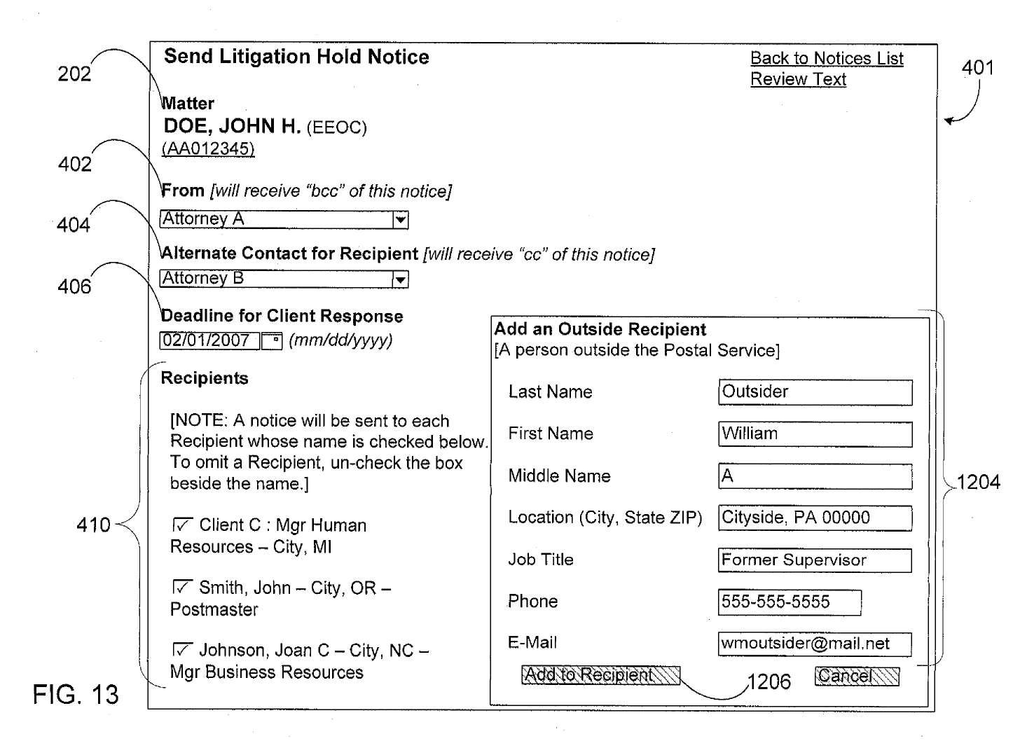

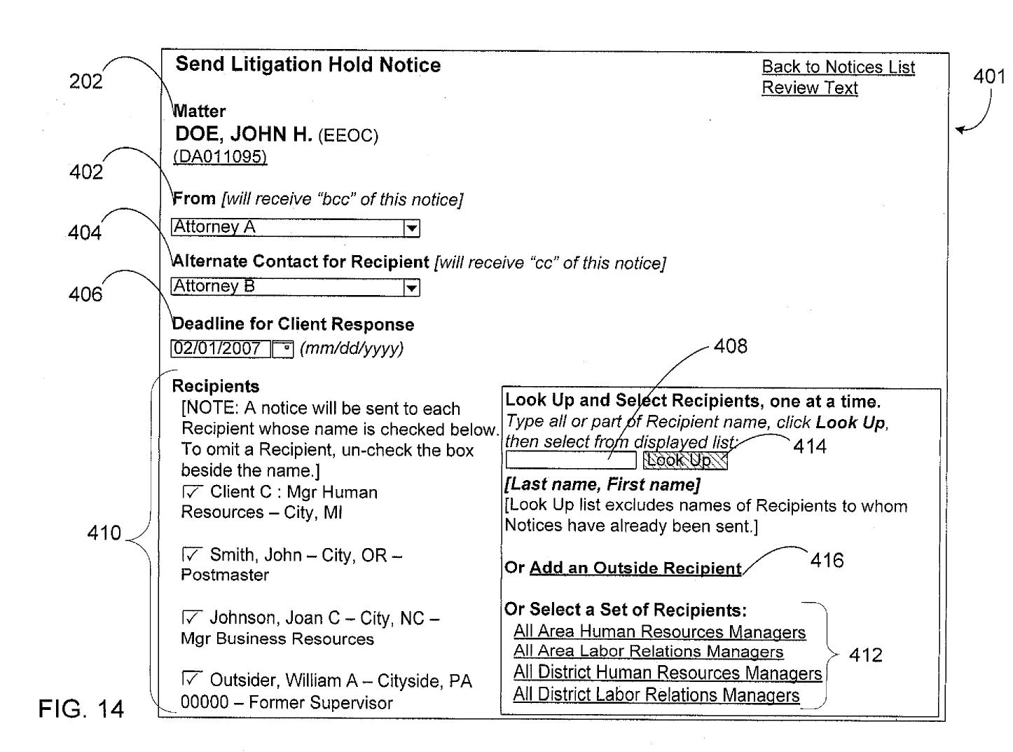

FIG. 13 illustrates the same recipient input interface 401 as FIG. 12 with an outside recipient's information input into the outside recipient information fields 1204. FIG. 14 illustrates the updated recipient input interface 401 with the outside recipient “Outsider, William A” added to the recipient list 410. In one embodiment, an outside recipient can also be looked up in a manner similar to that shown in FIGS. 5-11 for inside recipients rather than inputting the information about the outside recipient each time.

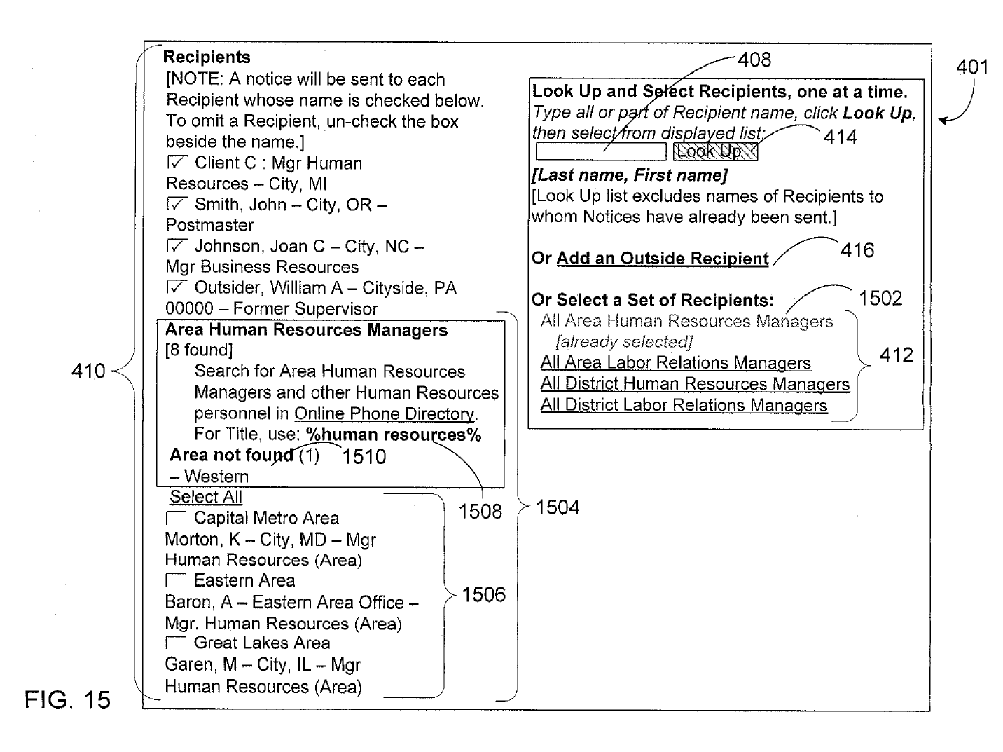

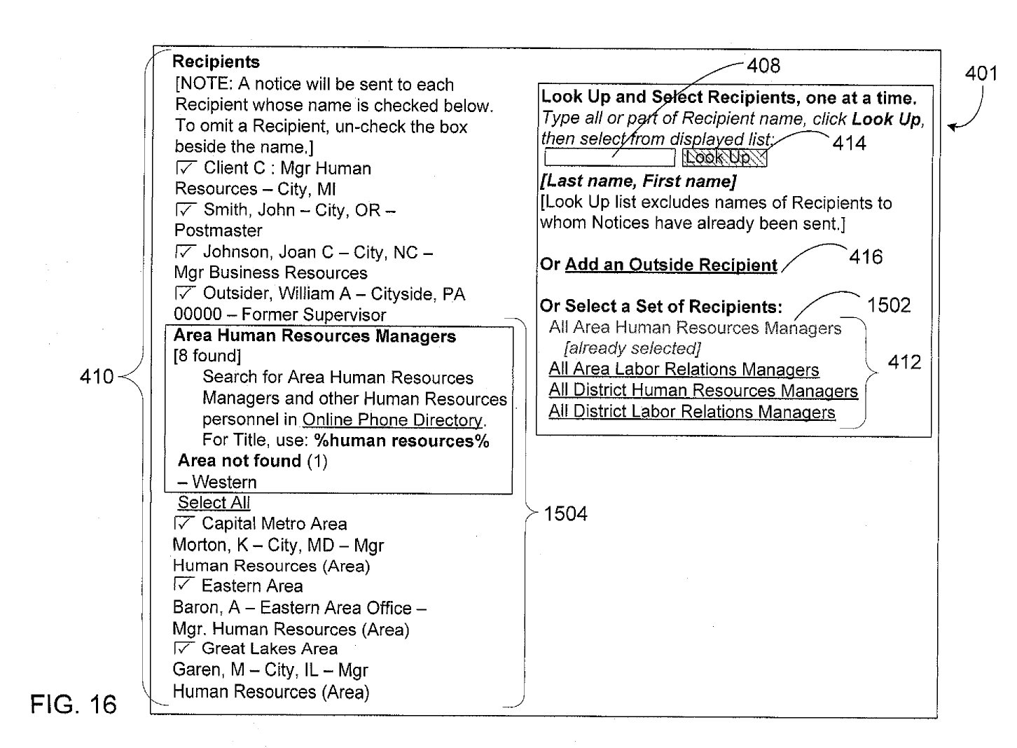

FIGS. 15 and 16 are screenshots illustrating one embodiment of the recipient input interface 401 for receiving a list of recipients of a litigation hold notice. FIGS. 15 and 16 illustrate adding a group of recipients to the recipient list 410. Selecting one of the set of recipients options 412 allows groups of individuals to be added to the recipient list 410. In one embodiment, the group options include departments in the organization. In one embodiment, the group options displayed are always the same. In another embodiment, the groups options are dynamically populated. For example, in one embodiment, the group options are selected from the organization's email directory. In another embodiment the groups listed in the set of recipients options 412 include groups stored in the database 102 or in another database.

Once a group of recipients from the set of recipient options 412 has been selected, the hold administrator interface module 108 updates the recipient input interface 401. In one embodiment, the hold administrator interface module 108 updates the recipient input interface 401 so that the selected group is added to the recipient list 410. In another embodiment, the hold administrator module 108 updates the recipient input interface 401 so that subgroups of the selected group are added to the recipient list 401. The subgroups may be chosen in any suitable manner, such as through information stored in a database.

FIG. 15 illustrates the recipient input interface 401 after an administrator has selected a human resources group option 1502 from the set of recipient options 412. Information regarding human resources managers is shown in human resources recipient group 1504 in the recipient list 410. In one embodiment the human resources recipient group 1504 is populated with information from the organization's Active Directory. The administrator may select the phone directory option 1508 to choose from a list of individual human resources managers listed in a phone directory.

In one embodiment, the hold administrator interface module 108 displays subgroups of a group of recipients. For example, as shown in FIG. 15, the recipient interface 401 displays human resources manager subgroup options 1506. In one embodiment, a subgroup of a set of recipients is displayed based on areas or districts. For example, a subgroup may be displayed for each area or district in which an employee with the selected job title can be found as shown by human resources manager subgroup options 1506. In one embodiment, the hold administrator interface module 108 also displays areas for which a person with the job title cannot be found, as shown by district 1510 in FIG. 15. FIG. 16 illustrates the recipient input interface 401 from FIG. 15 in which some of the human resource manager options 1506 in the recipient list 410 have been selected.

In one embodiment, the hold administrator interface module 108 generates an interface that allows an administrator to design a litigation hold notice. In one embodiment, the litigation hold notice describes the litigation matter and the types of materials that are to be preserved.

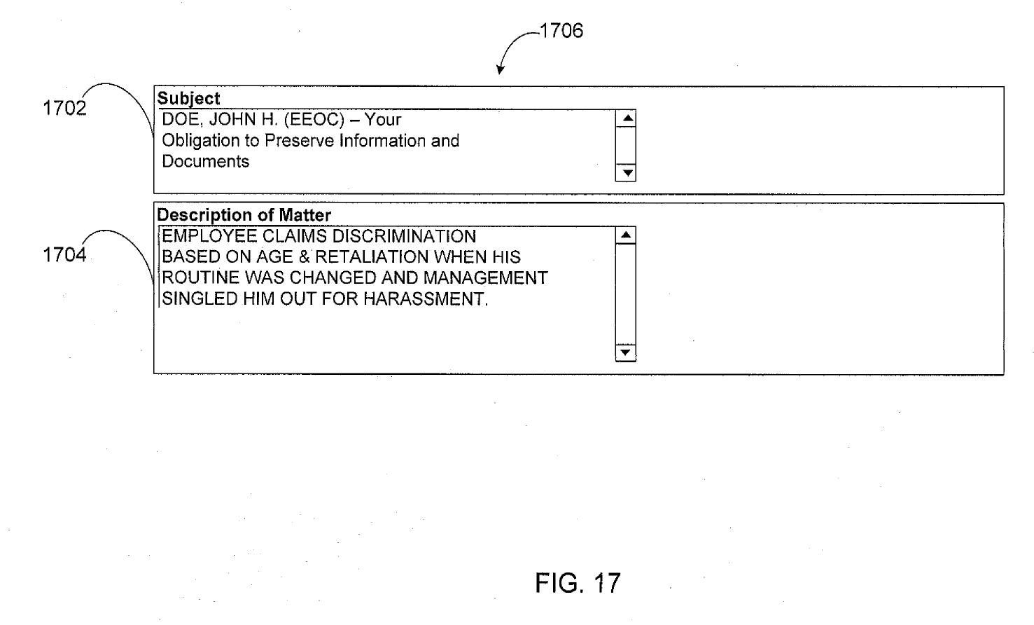

FIGS. 17-20 are screenshots illustrating embodiments of a litigation hold notice input interface 1706 for describing the litigation hold obligation. The litigation hold notice input interface 1706 may be generated by the hold administrator interface module 108. In one embodiment, the litigation hold notice input interface 1706 allows the administrator to input a wide variety of information into the litigation hold notice.

In one embodiment, the litigation hold notice input interface 1706 allows an administrator to customize the litigation hold notice so that the language in the litigation hold notice is specific to the particular litigation matter. In one embodiment, the litigation hold notice input interface 1706 initially includes standard language that is the same for all litigation matters describing the litigation hold obligation. In one embodiment, the litigation hold notice input interface 1706 allows an administrator to provide information such as a description of the litigation matter and types of materials to be preserved for it. In another embodiment, the litigation hold notice input interface 1706 may also allow an administrator to add an additional note to the litigation hold notice.

FIG. 17 illustrates one embodiment of the litigation hold notice input interface 1706. A subject field 1702 allows the administrator to input a subject of the litigation. In one embodiment, the text entered into the subject field 1702 is the subject line of a litigation hold notice email. The litigation hold notice input interface 1706 may also include a description field 1704 in which the administrator may enter a description of the litigation matter. The description may be helpful to inform a recipient about the scope of materials that may be relevant to the litigation. The subject field 1702 and the description field 1704 may be initially populated with stored values. For example, the values may be populated from a litigation management system such as the USPS' Litigation Management System. In another embodiment, the subject field 1702 and the description field 1704 are populated with information stored in the database 102.

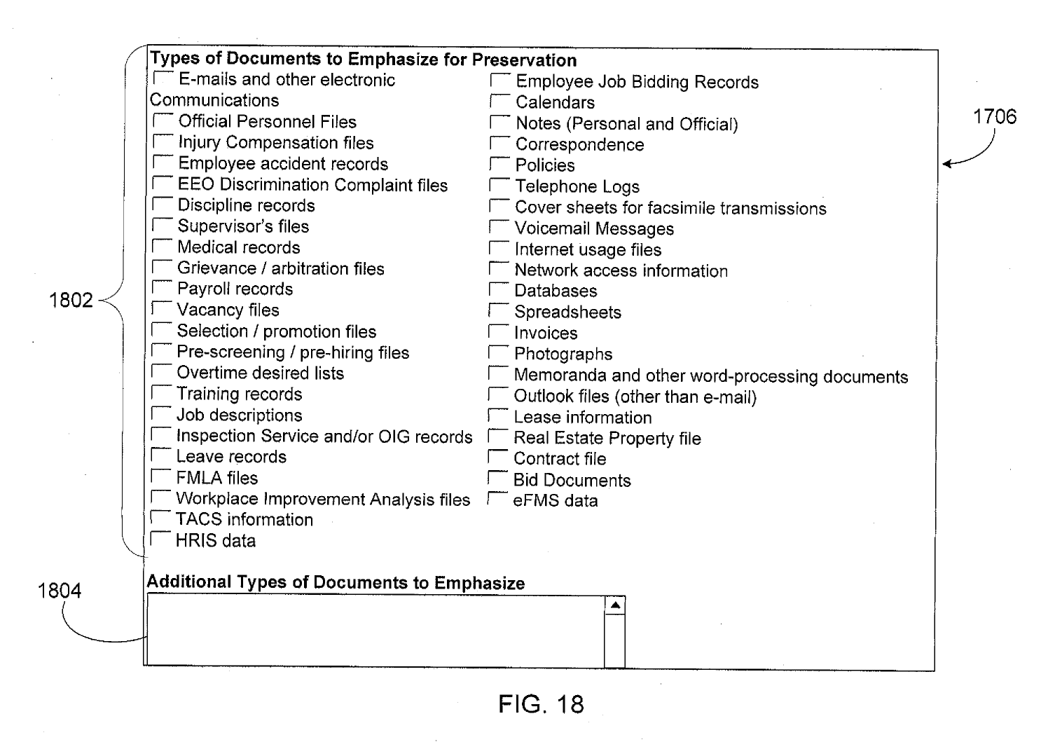

FIG. 18 is a screenshot illustrating another embodiment of the litigation hold notice input interface 1706. The litigation hold notice input interface 1706 may include a types of materials list 1802 and an additional materials field 1804. The types of materials list 1802 allows an administrator to indicate which types of materials should be preserved for the litigation. The types of materials list 1802 may include, for example, notes, correspondence, and photographs. In one embodiment, the list of possible materials to be displayed on the litigation hold notice input interface 1706 is retrieved from the database 102. The additional materials field 1804 allows an administrator to specify types of materials to be preserved which are not listed in the types of materials list 1802. In one embodiment, the litigation hold notice includes general language intended to direct the recipient to preserve all forms of records and other evidence relevant to the litigation. However the litigation hold notice input interface 1706 may allow an administrator to select particular types of documents and other materials to emphasize in the litigation hold notice.

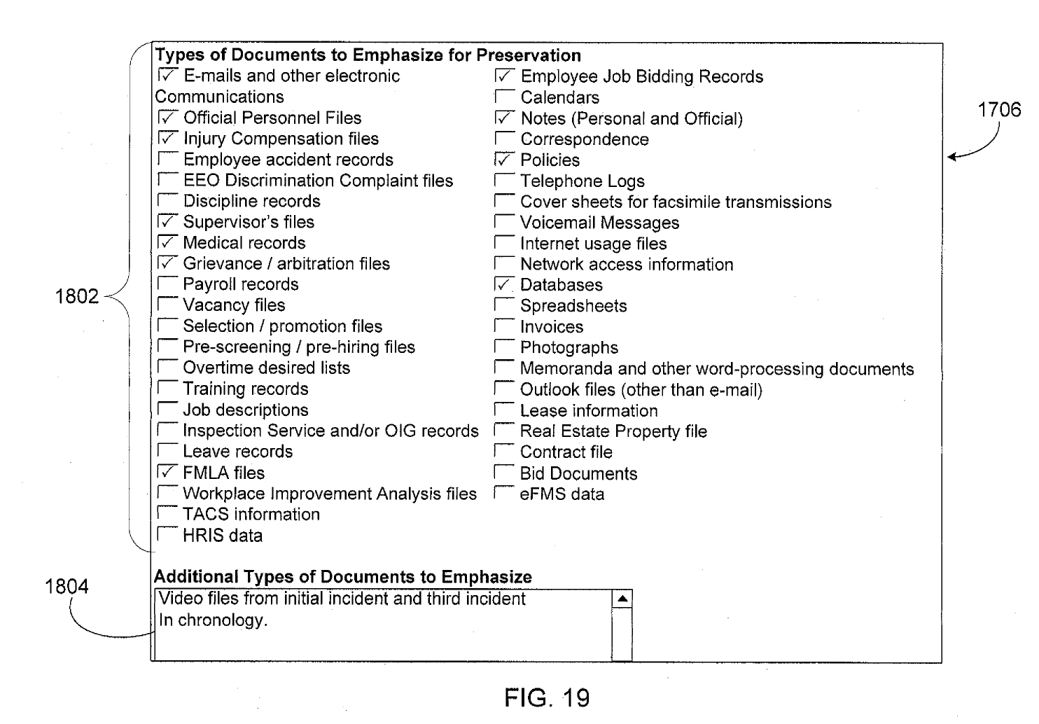

FIG. 19 is a screenshot illustrating another embodiment of the litigation hold input interface 1706. The types of materials list 1802 has some materials checked and the additional materials field 1804 has been filled out. The checked items would then be listed in the generated litigation hold notice along with the materials listed in the additional materials field 1804.

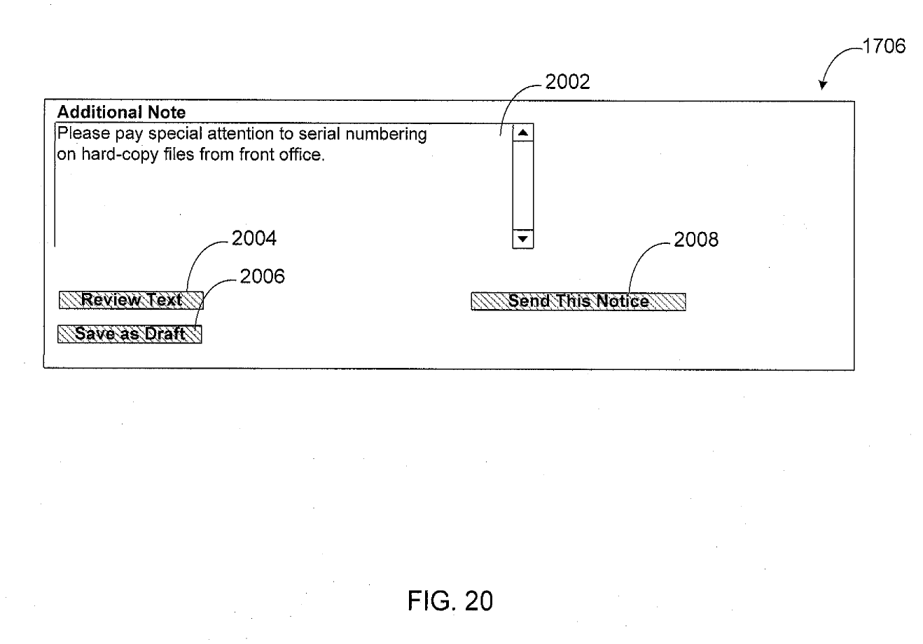

FIG. 20 is a screenshot illustrating another embodiment of the litigation hold notice input interface 1706. The additional note field 2002 allows an administrator to add an additional note to the litigation hold notice. Review text button 2004, send button 2008, and save draft button 2006 provide options for the administrator.

In one embodiment, a litigation hold notice includes a preservation and disclosure form for a recipient of a litigation hold notice to respond regarding his compliance with the notice. In one embodiment, the preservation and disclosure form is the same for all litigation matters.

In another embodiment, the administrator can customize the preservation and disclosure form. For example, the hold administrator interface module 108 may generate an interface that allows an administrator to customize the preservation and disclosure form that the recipient of the litigation hold notice will fill out. In one embodiment, the administrator can select questions from a list of standard questions that should be included in the preservation and disclosure form. The standard questions may be stored in the database 102. In another embodiment, the administrator may also add new questions to the preservation and disclosure form.

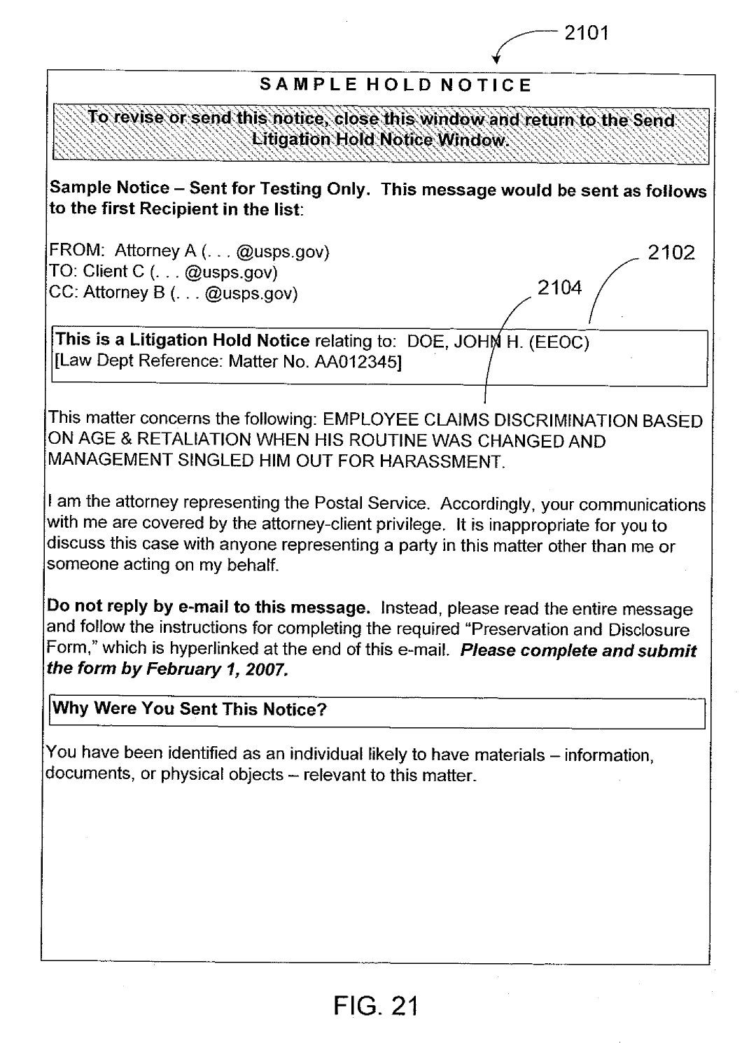

FIG. 21 is a screenshot illustrating one embodiment of a portion of a sample litigation hold notice 2101 that is generated if an administrator selects the review text button 2004 shown in FIG. 20. When an administrator selects the review text button 2004, the hold administrator interface module 108 generates an interface displaying a sample litigation hold notice 2101 which incorporates currently selected options and customized text. In one embodiment, a subject text 2102 displays the subject entered into the subject field 1702. In one embodiment, a description text 2104 displays the description entered into the description field 1704.

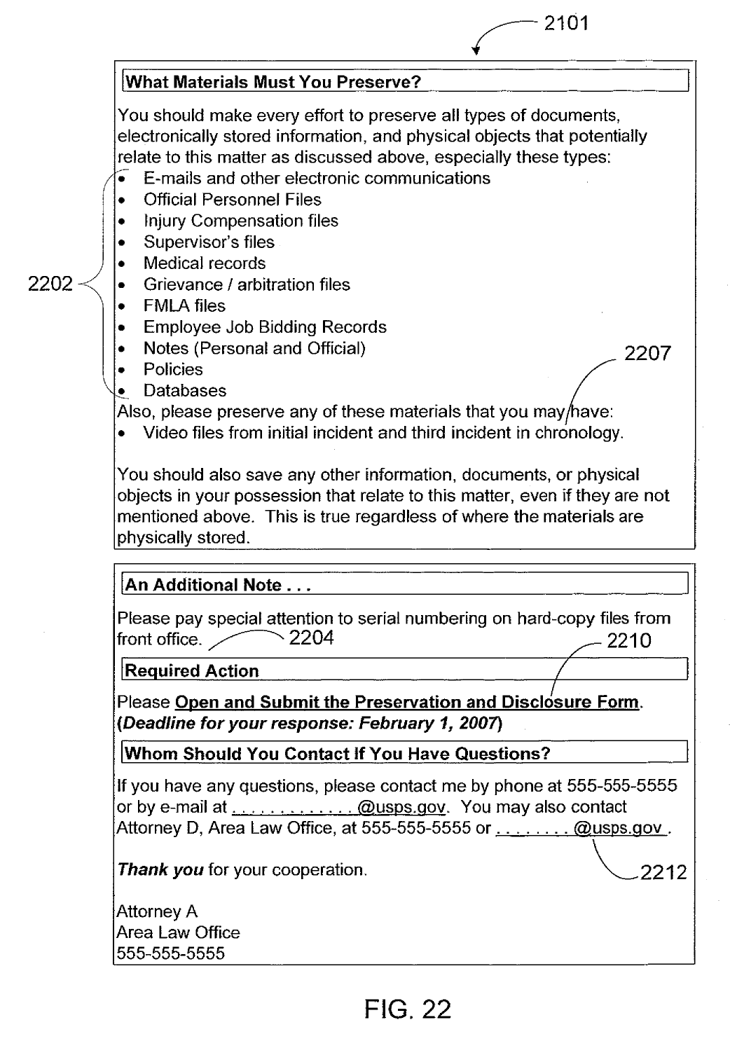

FIG. 22 is a screenshot illustrating another embodiment of a portion of the sample litigation hold notice 2101. In one embodiment, the portion of the sample litigation hold notice 2101 shown in FIG. 22 may be appended to the portion of the sample litigation hold notice 2101 shown in FIG. 21 so that they appear as a single notice. A materials list 2202 displays the materials selected from the types of materials list 1802. An additional materials list 2207 displays additional materials included in the additional materials field 1804. An additional note text 2204 displays the additional note from the additional note field 2002.

The contact information text 2212 provides the recipient of the litigation hold notice with additional contact information. In one embodiment the contact information is retrieved from a directory database. For example, the contact information could be retrieved from a law department internal staff directory database. In another embodiment, the contact information is retrieved from the database 102. In one embodiment, the contact information refers to the primary and alternate contact entered into the recipient input interface 401. A response form option 2210 leads a recipient to a preservation and disclosure form. In one embodiment, the preservation and disclosure form may be designed using a preservation and disclosure input interface. In another embodiment, the preservation and disclosure form may not be designed individually for each litigation hold notice.

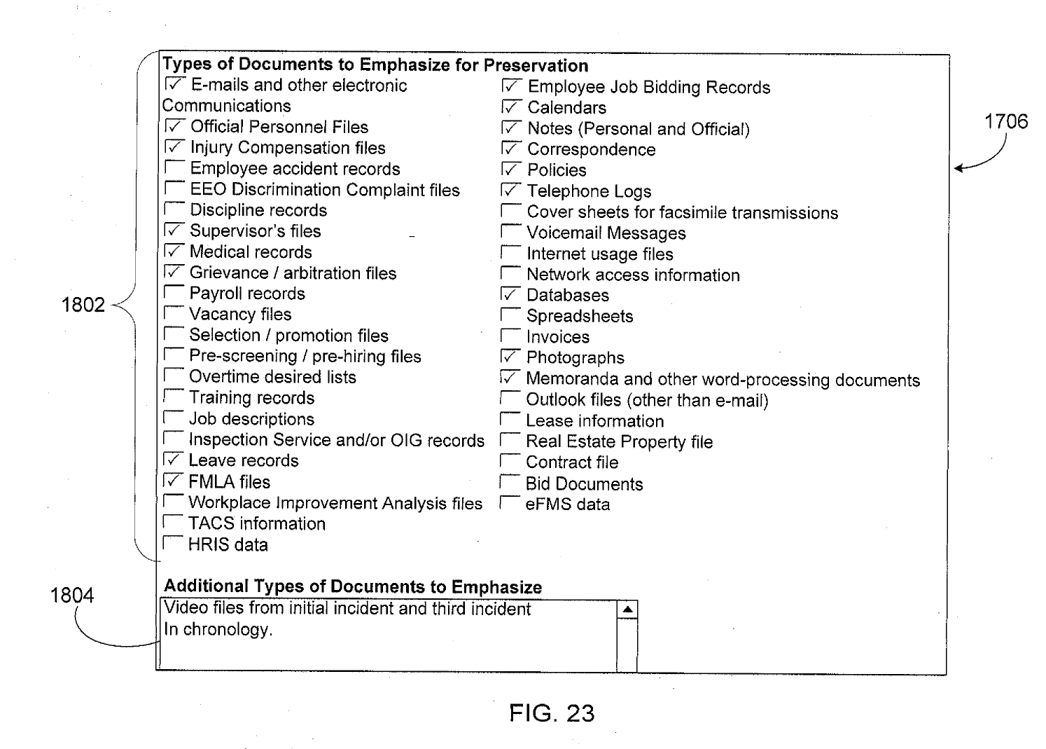

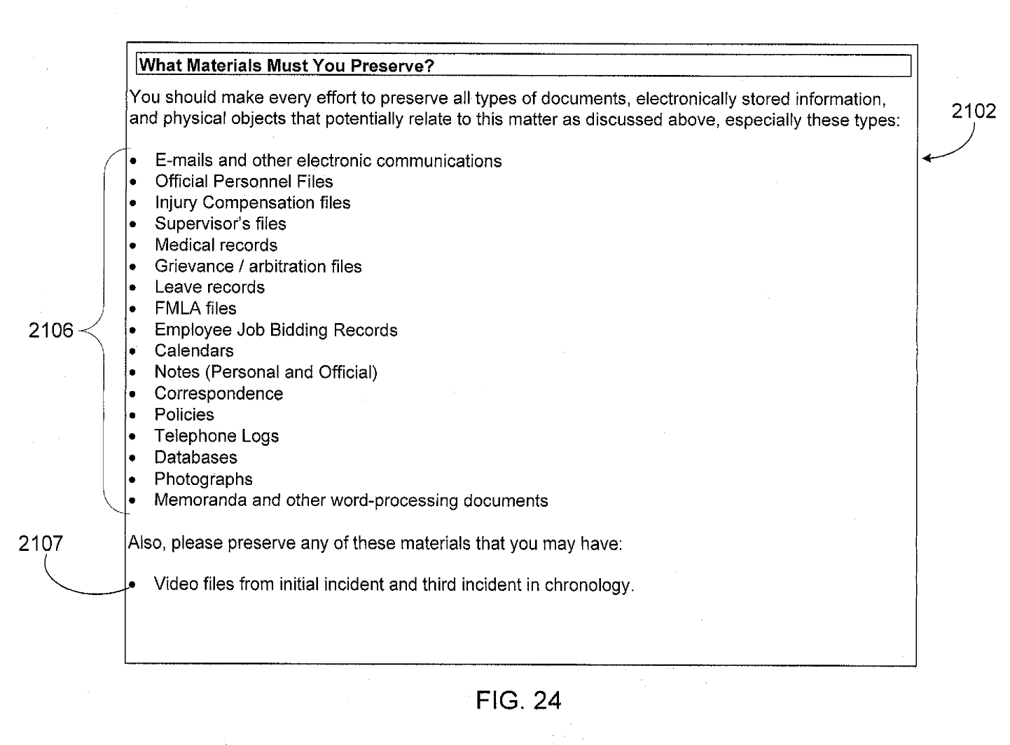

FIGS. 23 and 24 are screenshots illustrating embodiments of an updated litigation hold notice input interface 1706. After reviewing the complete litigation hold notice, the administrator can revise the litigation hold notice. For example, the administrator can return to the litigation hold notice input interface 1706 to update the types of documents to preserve. The administrator can then select the review text button 2004 again to view the updated text. For example, FIG. 24 is a screenshot illustrating the updated types of materials list 1802 and additional materials field 1804. FIG. 24 illustrates the updated sample litigation hold notice 2102 with the updated resulting types of materials list 2106 and additional materials list 2107 based on the updated information in the types of materials list 1802 and additional materials field 1804 shown in FIG. 23.

In one embodiment, the hold master control module 110 generates an email or other notice to notify someone that a draft of a litigation hold notice has been saved for review. Thus, a draft can be saved and reviewed later by another person.

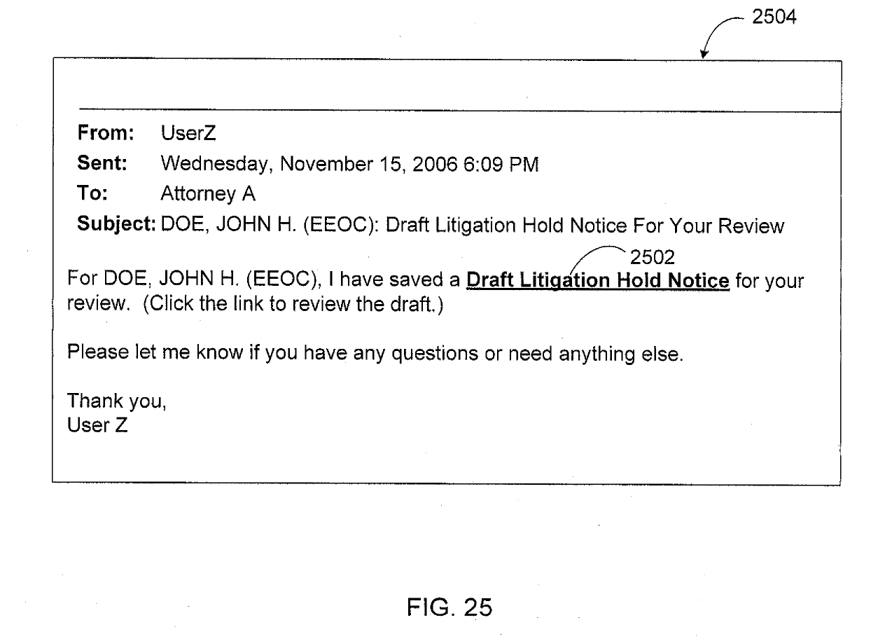

FIG. 25 is a screenshot illustrating one embodiment of a draft notification email 2504. The draft hold notice option 2502 links to a draft of the litigation hold notice. Referring back to FIG. 20, an administrator may select the save draft option 2006. When the save draft option 2006 is selected, the information input into the litigation hold input interface 401 and litigation hold notice interface 1706 is saved in the database 102. The save draft option 2006 allows an administrator to save a draft so that the administrator can make changes and finalize it later. In one embodiment, more than one version of a litigation hold notice may be saved for the same litigation matter.

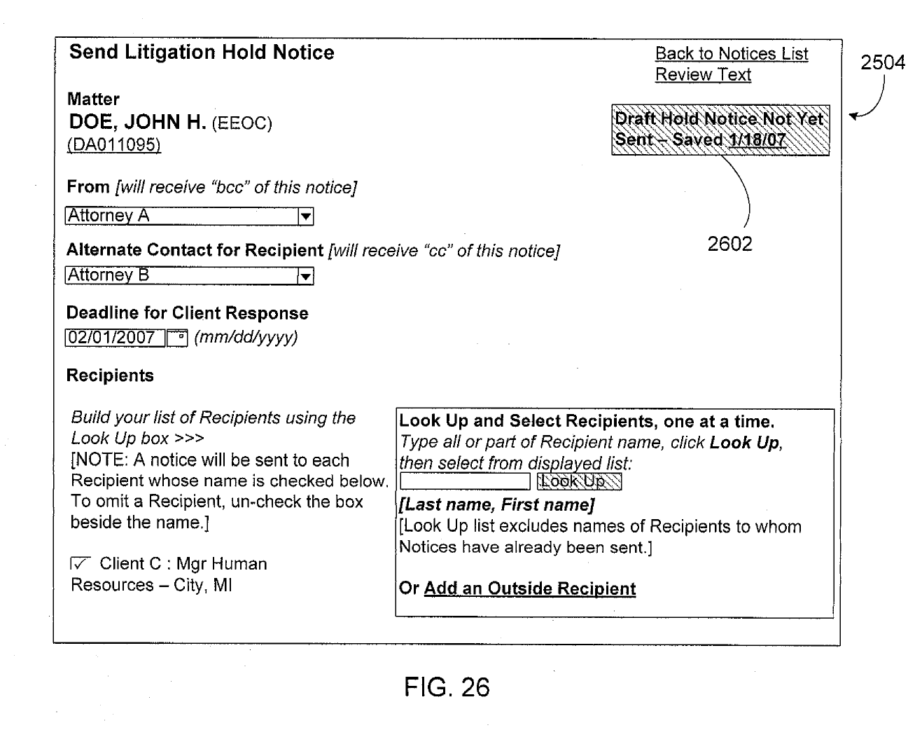

FIG. 26 is a screenshot illustrating on embodiment of a notification of a draft of a litigation hold notice. A draft link 2602 is a link to the draft of the litigation hold notice. In another embodiment, an administrator can access drafts of a litigation hold notice through a separate interface, such as a web interface. In one embodiment, the hold administrator interface module 108 generates an interface displaying all drafts of litigation hold notices or all drafts of litigation hold notices for a particular litigation matter.

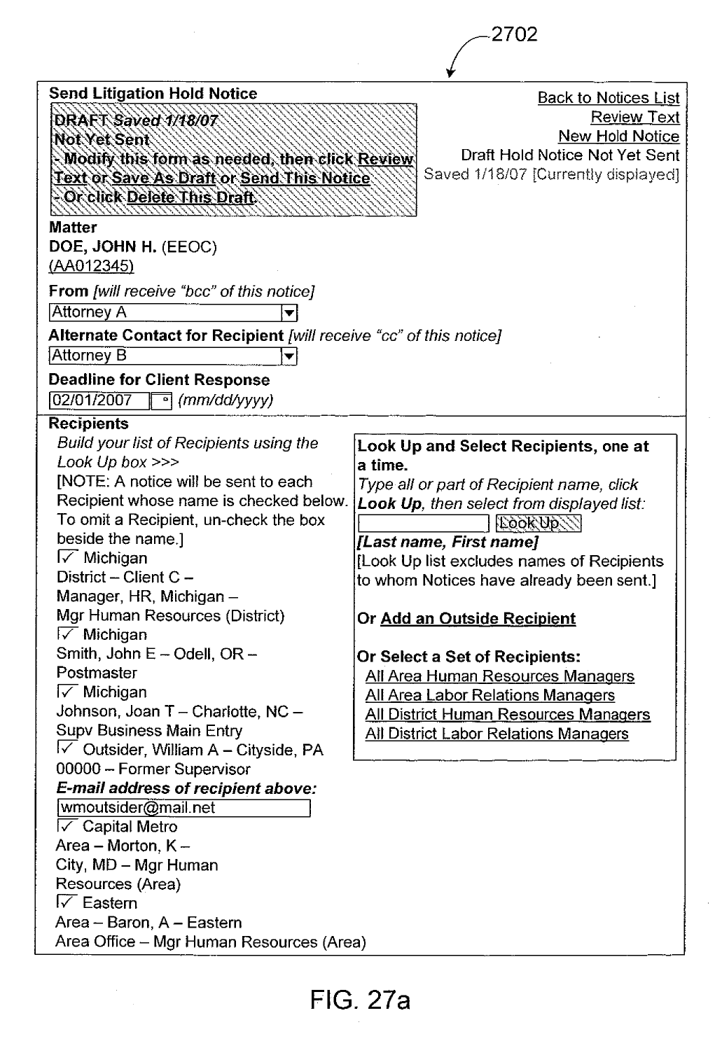

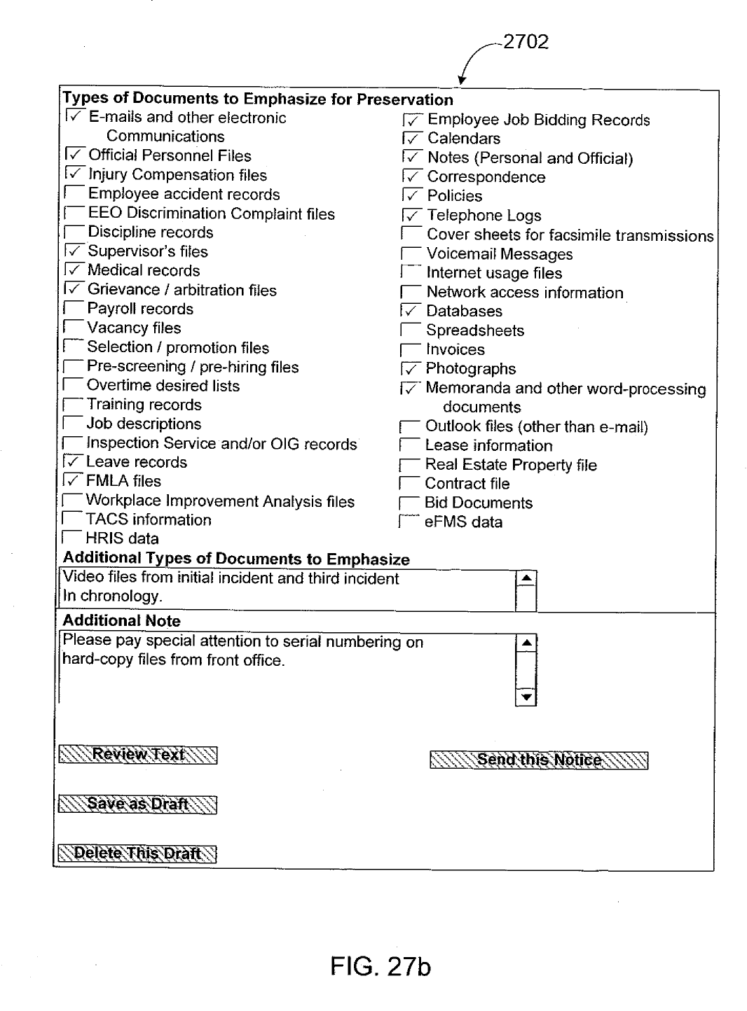

FIGS. 27a and 27b are screenshots illustrating embodiments of an interface displaying a litigation hold notice saved draft 2702. The hold administrator interface module 108 generates an interface displaying the draft litigation hold notice. The draft hold notice link 2502 from FIG. 25 may link to the litigation hold notice saved draft 2702. In one embodiment, the interface shown in FIG. 27a may be combined with the interface show in FIG. 27b to form a single interface.

The recipient input interface 401, litigation hold input interface 1706, and preservation and disclosure input interface may include all or portions of the embodiments discussed herein. The interfaces may appear differently than shown in the figures or described herein and may contain different fields than those discussed. The interface may appear in any manner suitable to achieve the desired functionality. The hold administrator interface module 108 may generate any combination of the recipient input interface 401, litigation hold input interface 1706, and preservation and disclosure input interface 2102. In one embodiment, the three interfaces are generated in a single interface. In another embodiment, the hold administrator interface module 108 does not generate all three interfaces. Any information in the litigation hold notice not provided through interface 401 or 1706 may be provided from information store in the database 102 or another database or directory.

In one embodiment, when an administrator selects to send the litigation hold notice, such as by selecting the send notice button 2008 shown in FIG. 20, the hold master control module 110 sends an email to each recipient or group of recipients in the recipient list 401. In one embodiment, information from the litigation hold notice input interface 1706 is contained in the body of the email. In one embodiment, the email contains a link to a web preservation and disclosure interface requesting information. In one embodiment, the information requested is described in the preservation and disclosure input interface. In another embodiment, a link in the body of the email leads the recipient to a web interface containing both the information from the litigation hold notice input interface 1706 and the preservation and disclosure form. In another embodiment, both the information from the litigation hold notice input interface 1706 and the preservation and disclosure form are included in the body of the email. In another embodiment, a separate program notifies an individual or group in the recipient list 410 to check a website regarding the information from the litigation hold notice input interface 1706 and the preservation and disclosure form.

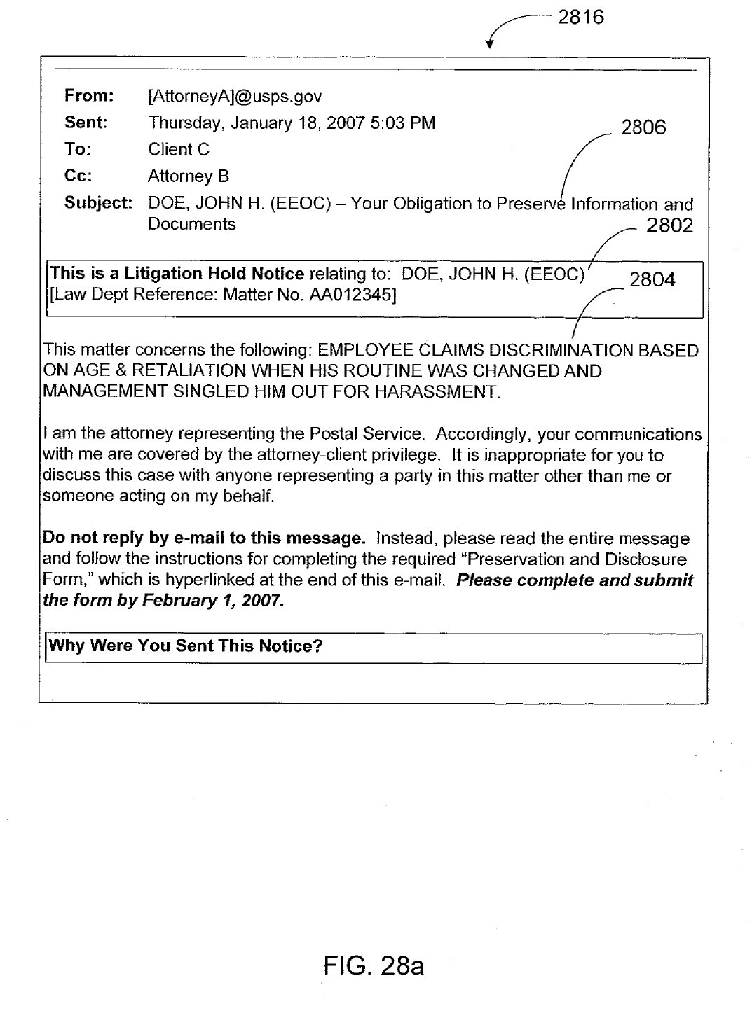

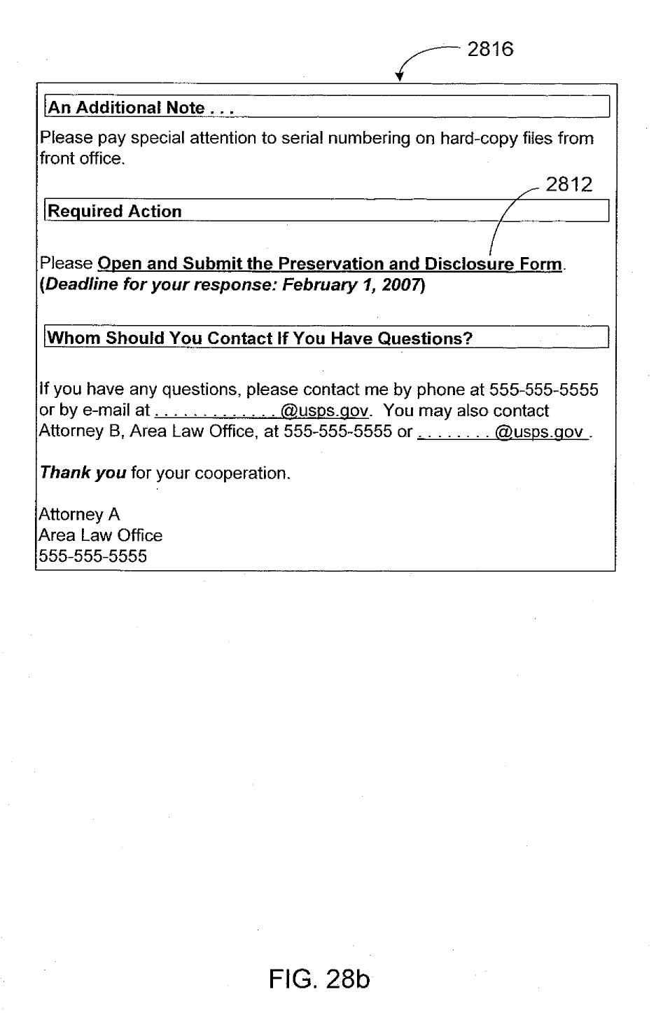

Referring back to FIG. 3, continuing to the block 304, the recipient interface module 106 generates a user interface for requesting information from the recipient. The recipient user interface is based on the information input into the litigation hold input interface 1706. In one embodiment, the recipient user interface is also based on the information input into the preservation and disclosure input interface. In another embodiment, the preservation and disclosure form is a standard form that is the same for all litigation hold notices. The information input into the litigation hold input interface 1706 and preservation and disclosure input interface is saved in the database 102 so that the hold master control module 110 can send the information to the recipient interface module 106. The recipient interface module 106 can then generate a recipient interface based on the saved settings. FIGS. 28a-31b are described below to further illustrate the actions performed at the block 304 of the method 301.

FIGS. 28a and 28b are screenshots illustrating embodiments of a litigation hold notice interface 2816 generated by the recipient interface module 106. In one embodiment, the interfaces shown in FIGS. 28a and 28b may be combined into a single interface. Email subject matter line 2806 and subject matter line 2802 relate to the subject entered into the subject matter field 1702 of the litigation hold notice input interface 1706 respectively. Description 2804 corresponds to the description entered into the description field 1704.

In one embodiment, a separate email may be sent to each recipient that was listed in the recipient list 410. In one embodiment, the from line of the email corresponds to the primary contact entered into the primary contact field 402 of the recipient input interface 401. The carbon copy email line may correspond to the alternate contact field 404 in the recipient input interface 401.

In one embodiment, a recipient of the litigation hold notice may forward the received emailed litigation hold notice to someone else inside or outside of the organization. For example, the recipient of the litigation hold notice may forward the litigation hold notice to other individuals inside and outside of the organization that may the recipient believes may have materials or information relevant to the litigation. The recipient of the forwarded email may respond to the preservation and disclosure form. His response would then also be stored in the database 102.

The litigation hold notice interface 2816, as shown in FIG. 28b, contains a disclosure form link 2812 that links to a preservation and disclosure interface where the recipient may enter information regarding his compliance with the litigation hold.

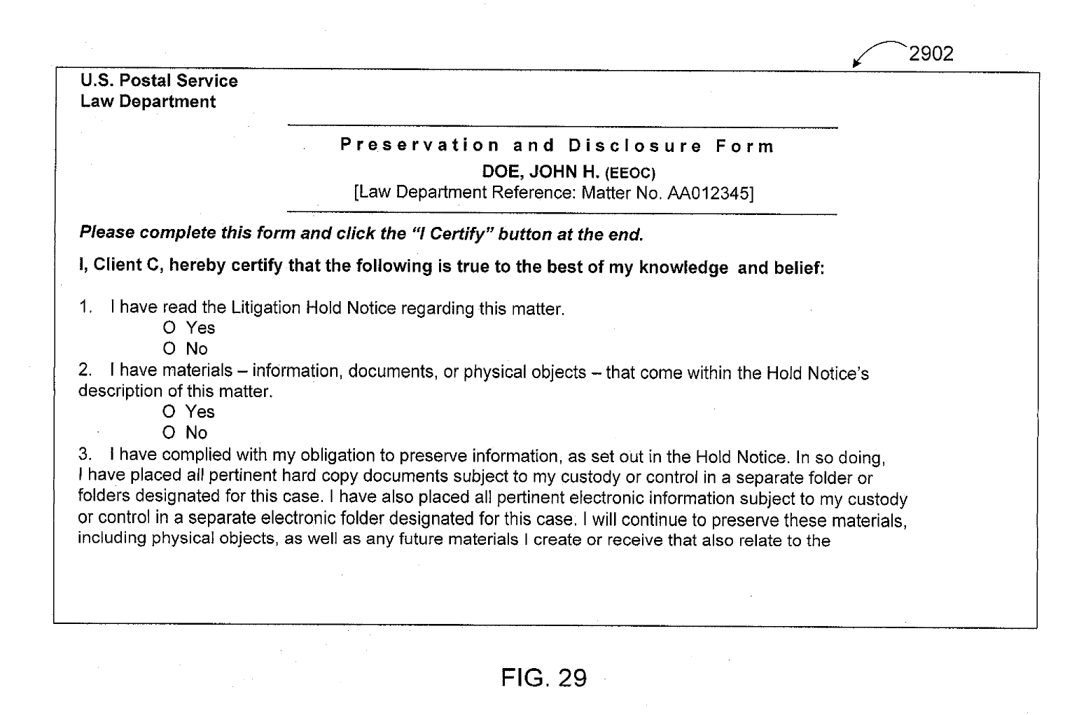

FIG. 29 is a screenshot illustrating one embodiment of a disclosure and preservation interface 2902 generated by the recipient interface module 106. When a recipient clicks on the disclosure link 2812 from FIG. 28b, the disclosure and preservation interface 2902 is generated. FIG. 29 illustrates a blank disclosure and preservation interface 2902 prior to a recipient entering any information.

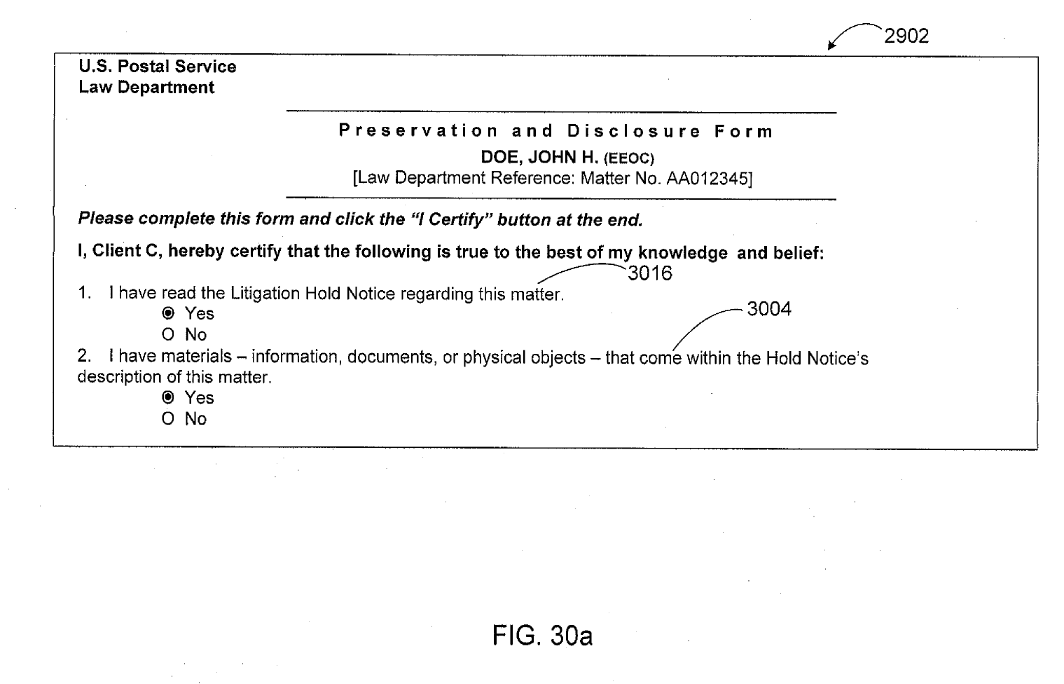

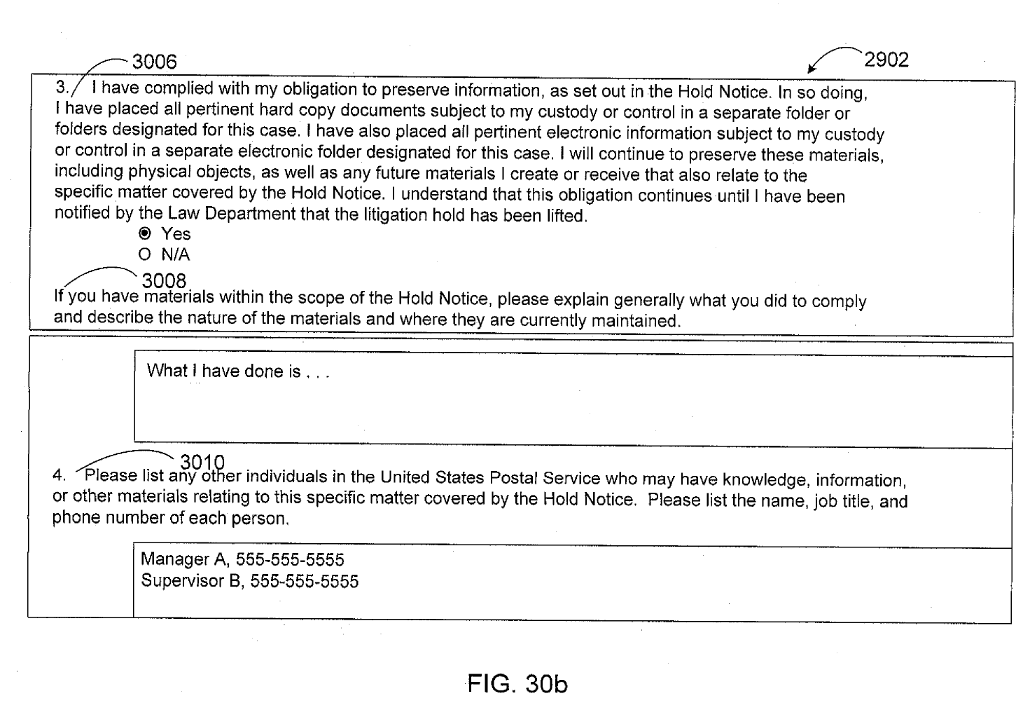

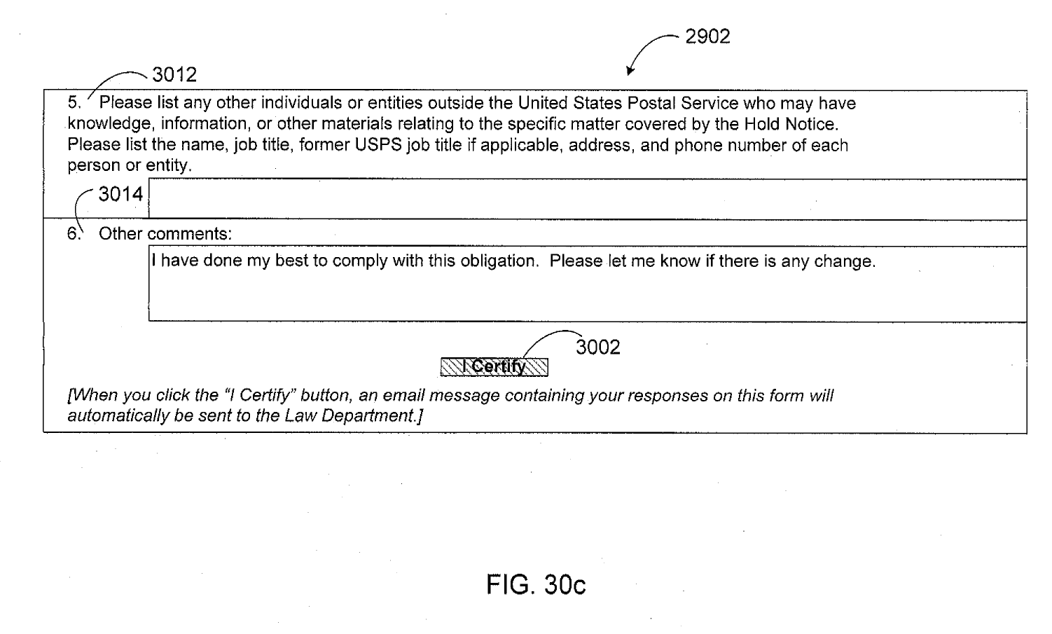

FIGS. 30a, 30b, and 30c are screenshots illustrating embodiments of a disclosure and preservation interface 2902. In one embodiment, the disclosure and preservation interface 2902 is generated based on the information input into the preservation and disclosure input interface. In another embodiment, the disclosure and preservation interface 2902 is the same for all litigation matters.

The preservation and disclosure interface 2902 may request a recipient of the litigation bold notice to enter a variety of information. The information requested by the preservation and disclosure interface 2902 is not limited to the information discussed herein, and any appropriate information may be requested. In one embodiment, the preservation and disclosure interface 2902 allows a recipient to provide both Boolean and text answers.

FIGS. 30a, 30b, and 30c illustrate some of the information that may be requested in the preservation and disclosure interface 2902. The information requested in the preservation and disclosure interface 2902 may include a question such as a question 3016 asking whether the recipient has read the litigation hold notice. The preservation and disclosure interface 2902 may also request a certification that the recipient is in possession of materials that should be preserved for the litigation. For example, a question 3004 asks whether the recipient is in possession of materials that come within the litigation hold notice. The recipient may then certify this response by selecting a certification button 3002.

The information requested from the preservation and disclosure interface 2902 may also include a description of the recipient's procedures for preserving the materials that should be preserved for the litigation. For example, a question 3006 asks whether the recipient has complied with the litigation hold notice as well as whether he understands his continuing obligation to comply. A question 3008 asks a recipient to describe what he has generally done to comply with the litigation hold notice, the nature of the materials that are relevant, and where the relevant materials are maintained.

A preservation and disclosure interface 2902 may further request and receive a list of other entities identified by the recipient as associated with materials to be preserved for the litigation. For example, a first prompt 3010 asks the recipient to list other internal personnel that may have materials relating to the matter. A second prompt 3012 asks the recipient to list people outside of the organization that may have information or materials relating to the litigation.

In one embodiment, the preservation and disclosure interface 2902 also allows the recipient to enter additional comments. For example, a third prompt 3014 asks whether the recipient has any additional comments. In one embodiment, the preservation and disclosure interface 2902 allows the recipient to certify his response once it is complete. For example, in one embodiment, the recipient may select the certification button 3002, as shown in FIG. 30c, to certify the response.

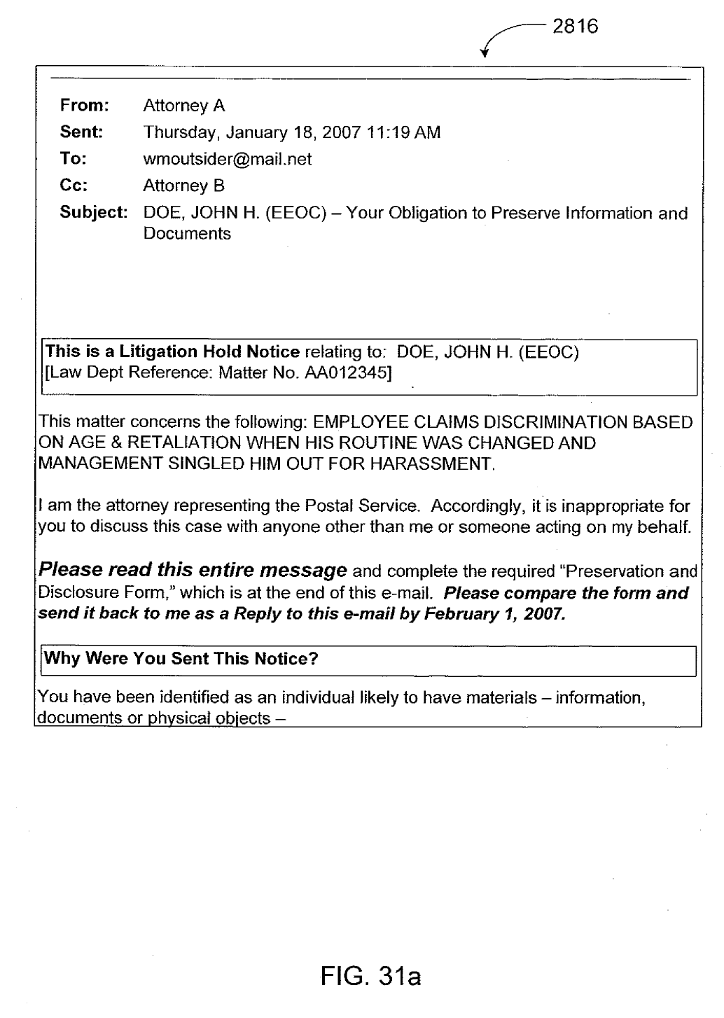

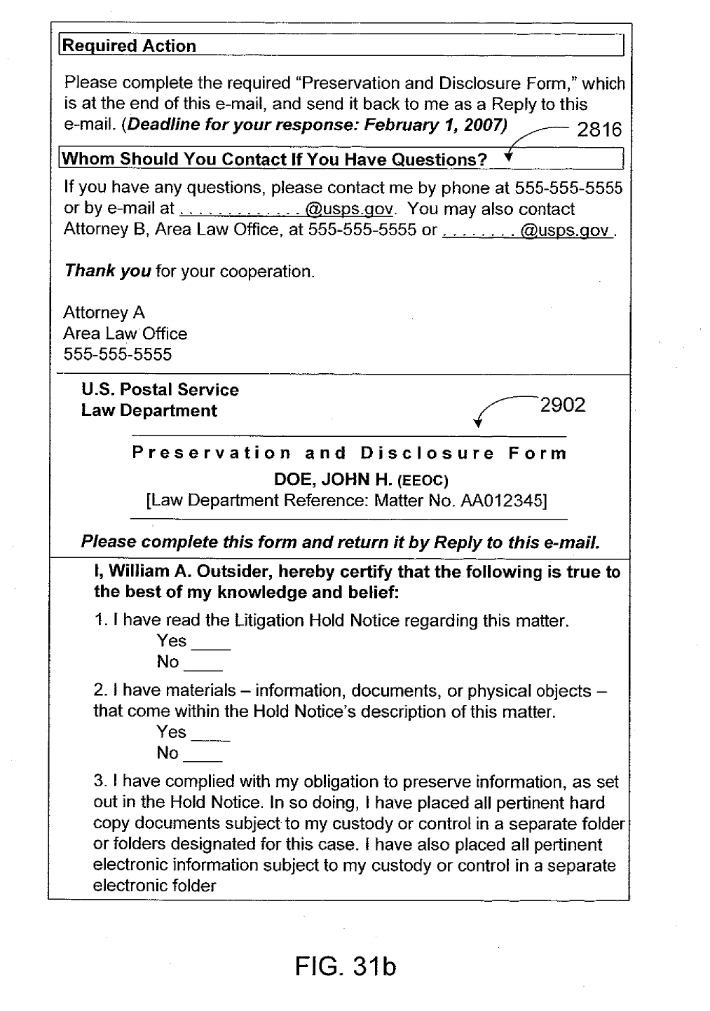

FIGS. 31a and 31b are screenshots illustrating embodiments of a preservation and disclosure interface for a recipient outside of an organization. The outside recipient may be, for example, a former employee. The preservation and disclosure interface 2902 may not be available to outside recipients as a web interface. Instead, in one embodiment, the preservation and disclosure interface 2902 is appended to an emailed litigation hold notice interface 2816. In one embodiment, an administrator or contact receives the emailed preservation and disclosure email. In one embodiment, an administrator or contact receives a blind carbon copy of the emailed preservation and disclosure email. In one embodiment, the preservation and disclosure interface 2902 may be appended to the bottom of the email litigation hold notice interface 2816. For example, the litigation hold interface 2816 shown in FIG. 31a and continued on FIG. 31b may have the preservation and disclosure interface 2902 appended to it. The outside recipient can reply to the email with the responses inserted into the body of the email. The outside recipient can then send the reply to the sender, such as an attorney. In another embodiment, an outside recipient may also respond to a web interface preservation and disclosure form, such as a password protected website.

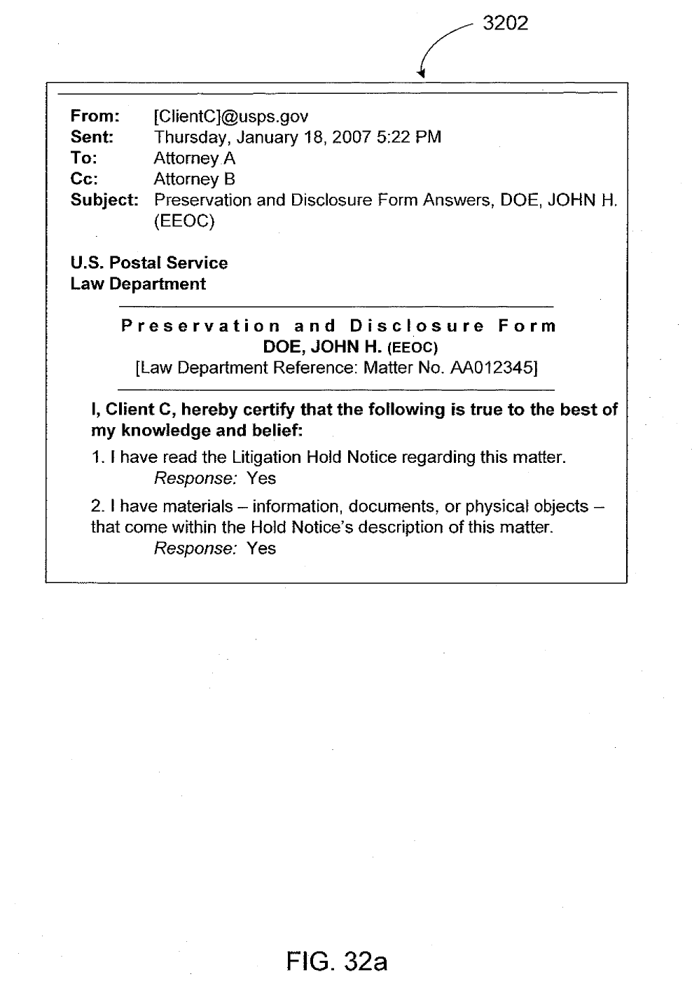

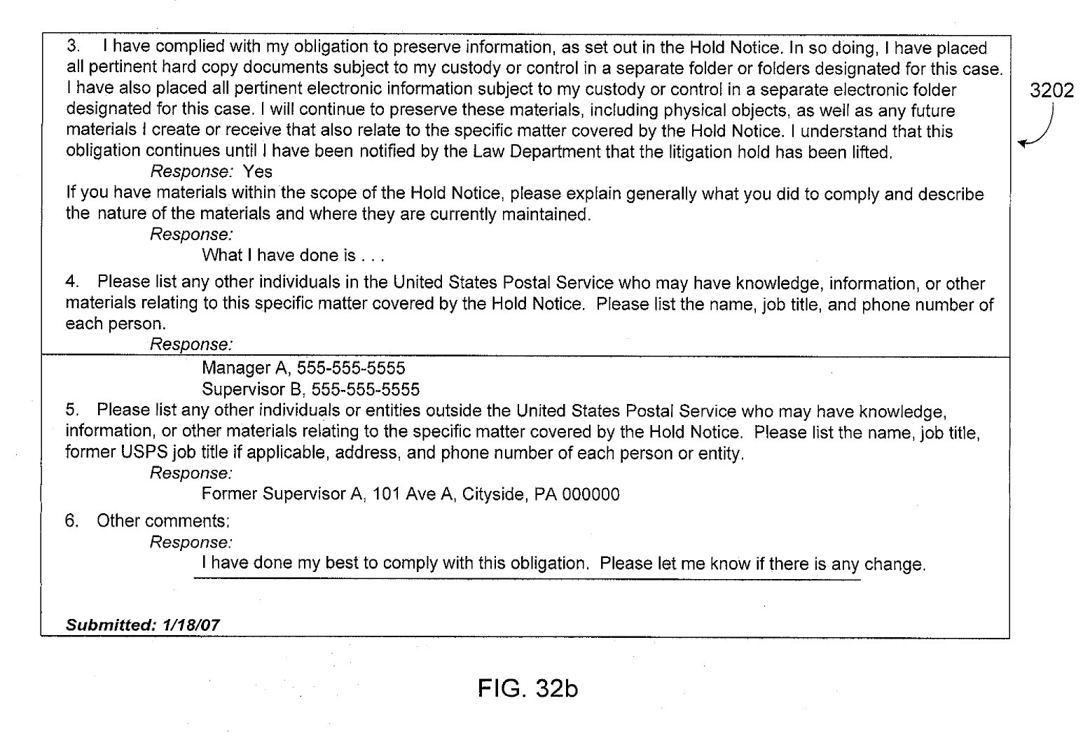

Referring back to FIG. 3, continuing to the block 306, the hold master control module 110 receives a response from the recipient. In one embodiment, the response is in the form of an email sent by the recipient. In another embodiment, the response is in the form of a web page submission. In one embodiment, an email is sent to notify an administrator that a web page submission has been received. Moving to the block 308, the hold master control module 110 stores the received response. In one embodiment, the hold master control module 110 stores the received response in the database 102. In another embodiment, the hold master control module 110 is an email server that stores the received response in an email sent to an identified contact. In one embodiment, the recipient of the response email may enter the responses into an interface generated by the hold administrator interface module 108 so that the responses are stored in the database 102. In one embodiment, the hold master control module 110 generates and sends an email to a contact with the recipient's response received from a web page submission. In one embodiment, the hold master control module 110 stores information about the response in the database 102. The information about the response may include, for example, the date the response was received. FIGS. 32a-35 are described below as to how they relate to the actions performed at the block 308 of the method 301.

FIGS. 32a and 32b are screenshots illustrating embodiments of a preservation and disclosure email response 3202 sent by the hold administrator interface module 110. In one embodiment, FIGS. 32a and 32b may be combined into a single interface. The preservation and disclosure email response 3202 includes the recipient's answers provided to the preservation and disclosure interface 2902. In one embodiment, the preservation and disclosure email response 3202 is sent after the recipient certifies the preservation and disclosure form.

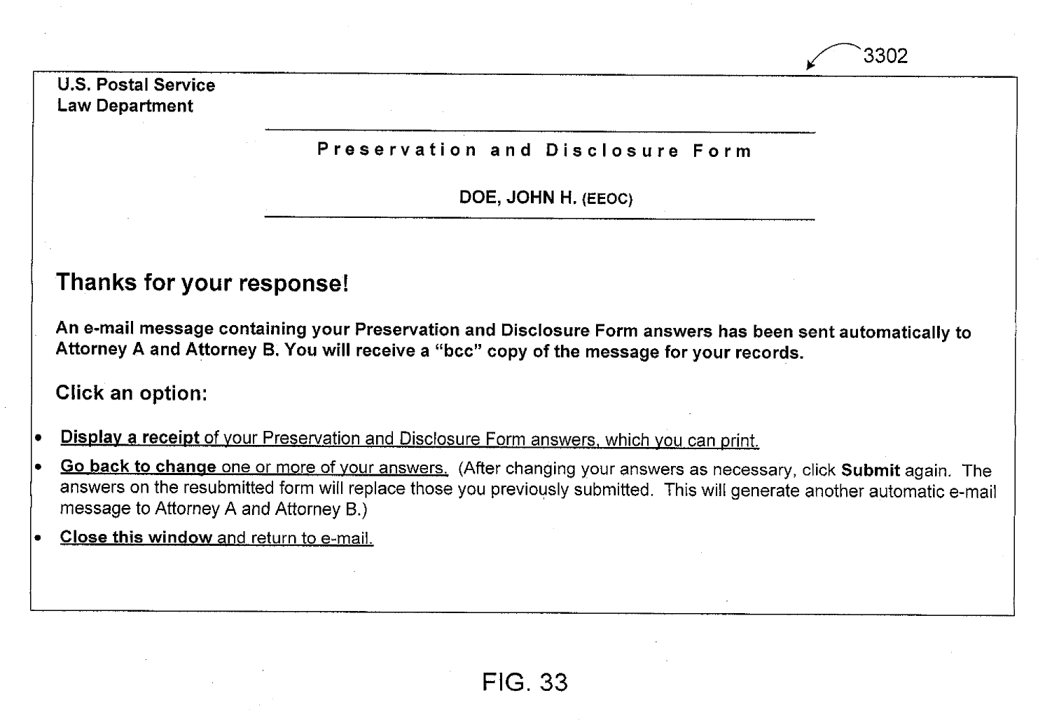

FIG. 33 is a screenshot illustrating one embodiment of a follow up message to the recipient's response to the preservation and disclosure interface 2902. Once the recipient's response has been submitted and the hold master control module 110 has received the response, the hold master control module 110 may send a follow up message, such as follow up message 3302 shown in FIG. 33, to the recipient of the litigation hold notice. In one embodiment, the follow up message is an email. In one embodiment, the follow up message 3302 indicates that the recipient's response has been received. In another embodiment, the follow up message allows a recipient to display a printable receipt of the recipient's response. In another embodiment, the follow up message 3302 allows a recipient to change his response. In one embodiment, the ability to print a receipt and change a response are provided through a web interface and no email is sent.

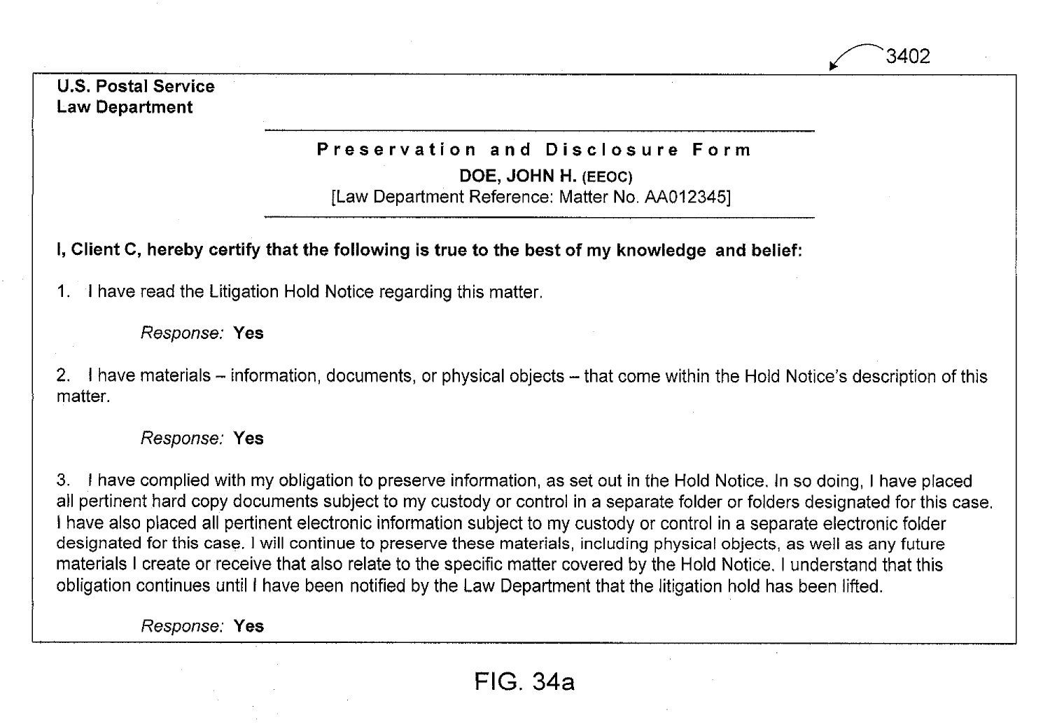

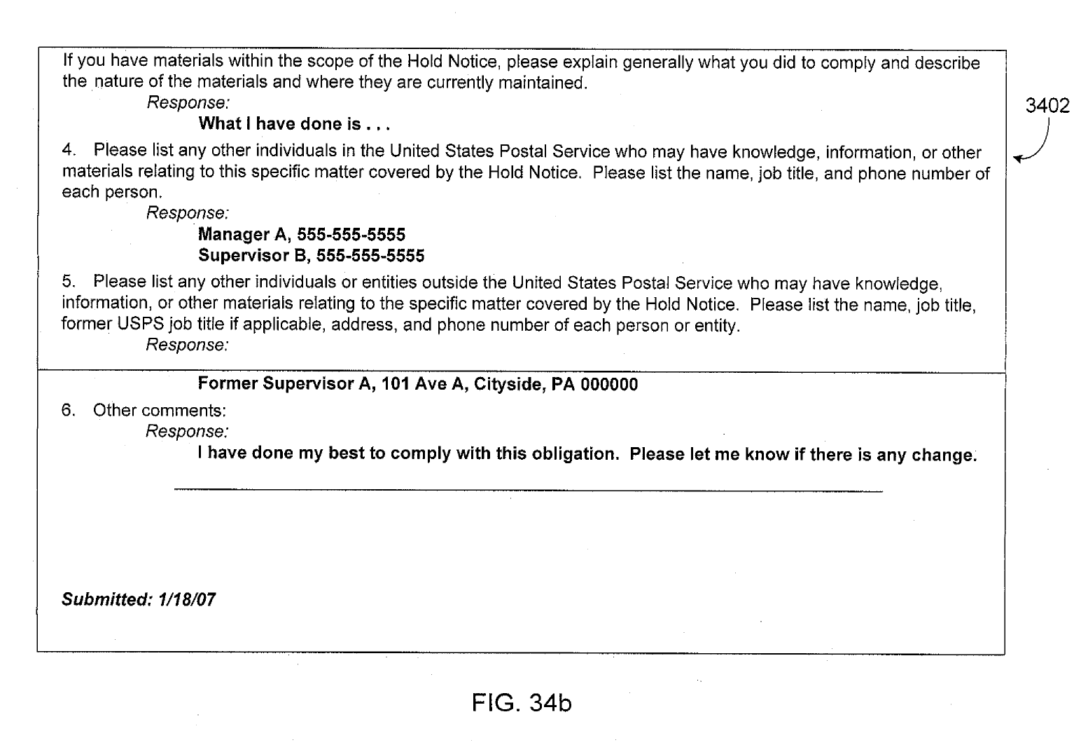

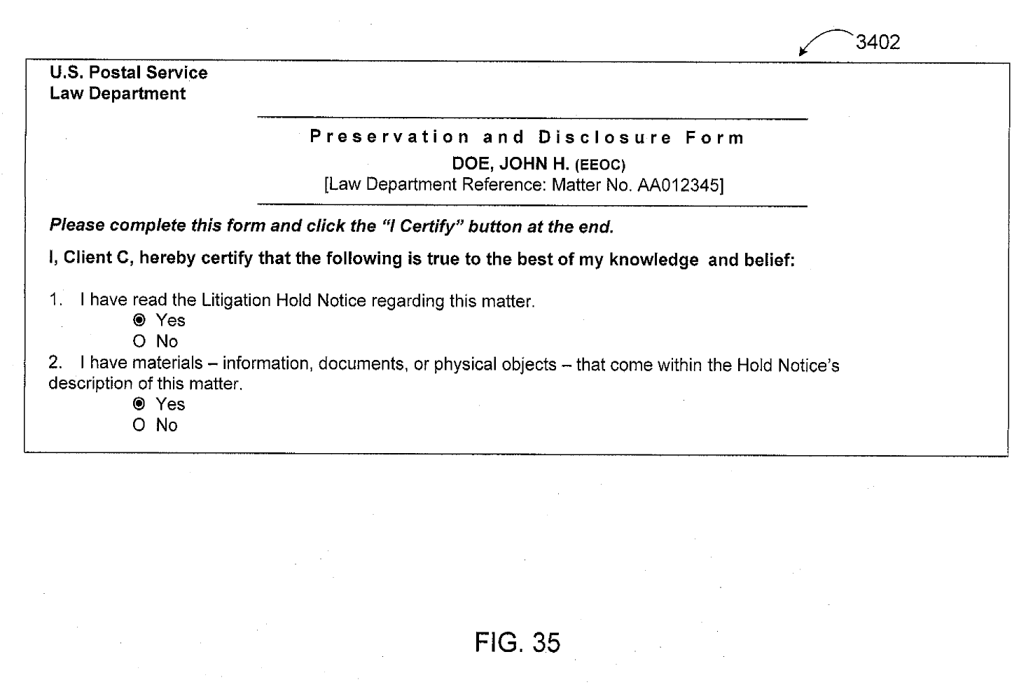

FIGS. 34a, 34b, and 35 are screenshots illustrating embodiments of a response receipt 3402 displaying a recipient's responses to the preservation and disclosure interface 2902. In one embodiment, the recipient interface module 106 generates the response receipt 3402 and populates the response receipt 3402 with information regarding the recipient's response stored in the database 102. FIGS. 34a and 34b illustrate one embodiment of a response receipt 3402 displaying the responses to the preservation and disclosure form. FIG. 35 illustrates one embodiment of a response receipt 3402 displaying a recipient's responses in a web interface. For example, the responses of an internal recipient may be shown in a web interface. The recipient may view his responses, for example, by selecting the appropriate link on a follow up message 3302.

After reviewing the response receipt 3402, the recipient can select an option to change his response. If a change response option is selected, the recipient interface module 106 generates an interface that allows an recipient to update his response to the preservation and disclosure form. The recipient can then update his response and certify the updated response.

Referring back to FIG. 3, moving to the block 310, the hold master control module 110 logs information about communications with the recipient. The hold administrator interface module 108 generates an interface allowing a hold administrator to view and manage the litigation hold notices and responses.

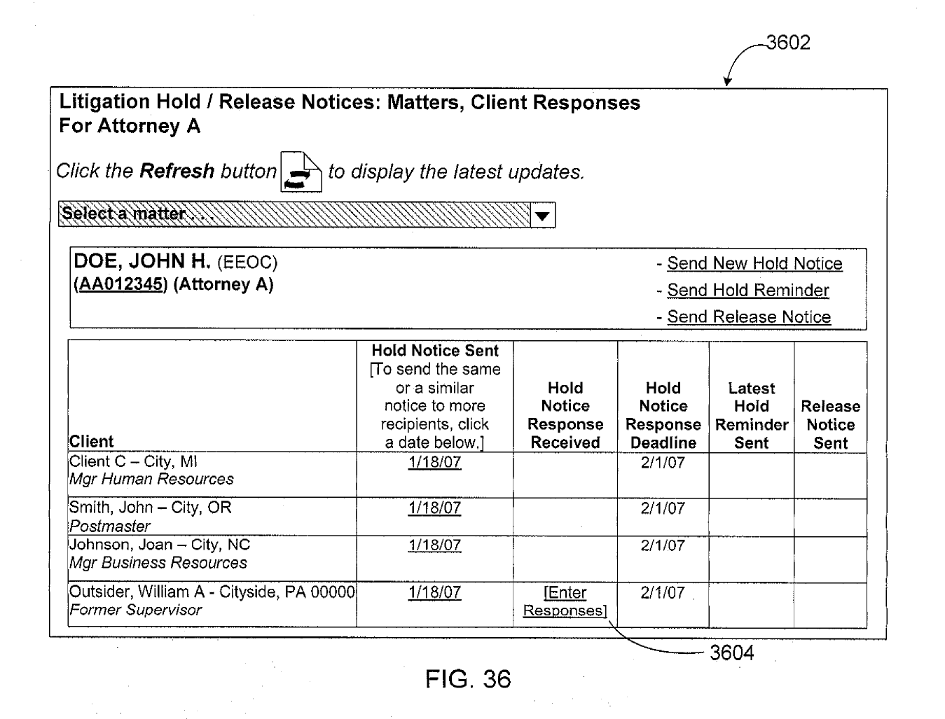

The recipient's responses are saved in the database 102. In one embodiment, an administrator can view the stored responses through an interface generated by the hold administrator interface module 108. In one embodiment, a report interface is a web interface. In another embodiment, the report interface is in the form of an email. For example, an administrator may receive an email containing the responses of a recipient of the litigation hold notice. In one embodiment, the hold administrator interface module 108 displays all recipients' or a subset of recipients' responses in a table or group form. In one embodiment, the hold administrator interface module 108 allows an administrator to search for recipients entering a particular response for a particular response item. For example, an administrator may be able to filter the report interface in order to only view recipients that responded that they are in possession of materials relevant to the litigation. This would allow an administrator to follow up with those particular recipients. FIGS. 36-43 are described below to further illustrate the actions performed at the block 310 of the method 301 in more detail.

FIG. 36 is a screenshot illustrating one embodiment of a report interface 3602 generated by the hold administrator interface module 108. To generate the report interface 3602, the hold master control module 110 retrieves information from the database 102 and sends it to the hold administrator interface module 108. The report interface 3602 may display any information stored in the database 102. For example, the report interface 3602 may display a list of recipients of the notice, the date the notice was sent, the date a response was received, and the deadline for a response. However, the displayed data is not limited to the data discussed herein. In one embodiment, a report is generated to display information about litigation hold notices and responses for all of the litigation matters assigned to the particular administrator. In another embodiment, an administrator with certain permissions, such as a manager, may see a report displaying information about all of the organization's litigation matters.

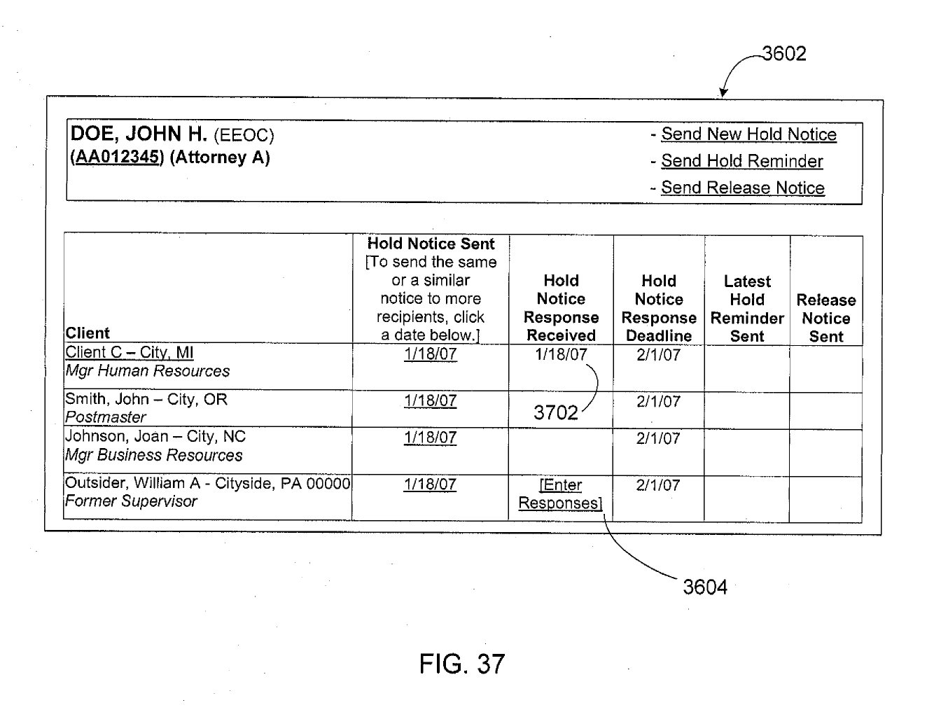

FIG. 37 is a screenshot illustrating another embodiment of the report interface 3602 generated by the hold administrator interface module 108. Hold notice receipt date 3702 displays the date the response was received from Client C. In one embodiment, for a recipient that has responded, the recipient's name in the report interface 3602 becomes a link to that recipient's response to the preservation and disclosure form. For example, the line under Client C shows that the name is a link to Client C's response. If the link is followed, the hold administrator interface module displays the particular recipient's response.

In one embodiment, an enter responses option 3604 allows an administrator to manually enter the responses received via email, such as response from an outside recipient. For example, an administrator may receive an email response from a recipient. The administrator can then enter the responses from the email into a preservation and disclosure interface generated by the hold administrator interface module 108.

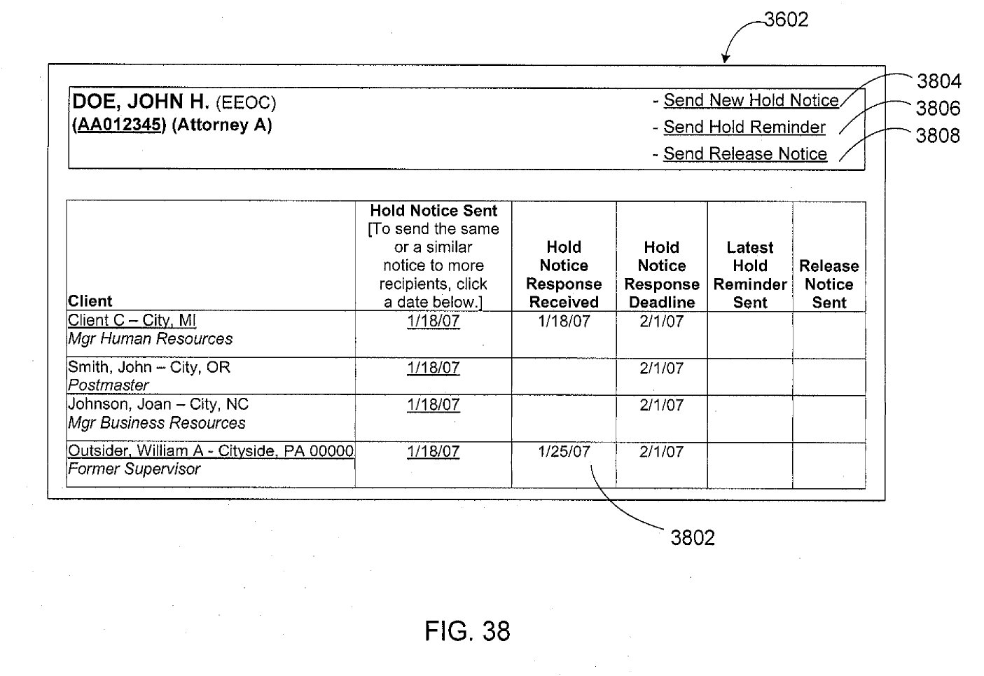

FIG. 38 is a screenshot illustrating another embodiment of the report interface 3602 generated by the hold administrator module 108. Once an administrator has entered the outside recipient's responses into the preservation and disclosure interface, the date of the receipt for the response from the outside recipient may be manually or automatically entered into the report interface 3602. In another embodiment, the hold master control module 110 determines the date on the outside recipient's email and stores it in the database 102. Response date 3802 shows the date that William Outsider responded to the litigation hold notice on Jan. 25, 2007.

In one embodiment, an additional litigation hold notice can be sent to an individual or group not on the recipient list 410. For example, the administrator can select a new hold notice option 3804 to send a new hold notice for the same litigation. A previously sent or designed hold notice can be sent to additional recipients. In another embodiment, the administrator can design a new litigation hold notice and preservation and disclosure form the updated list of recipients or modify the existing litigation hold notices and preservation and disclosure forms.

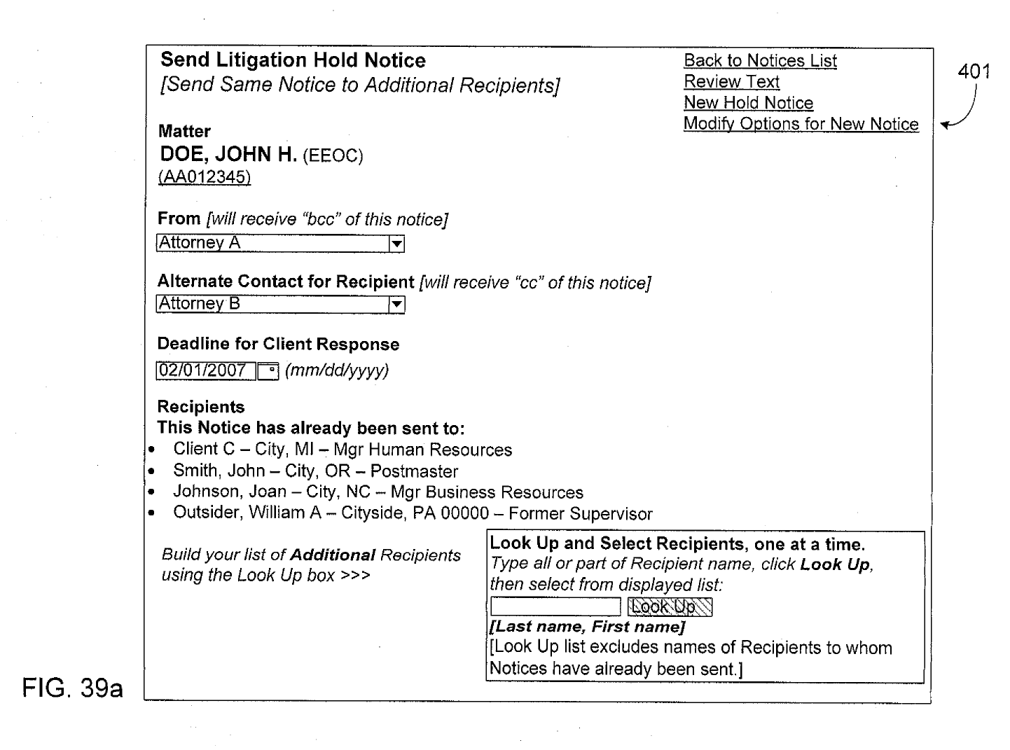

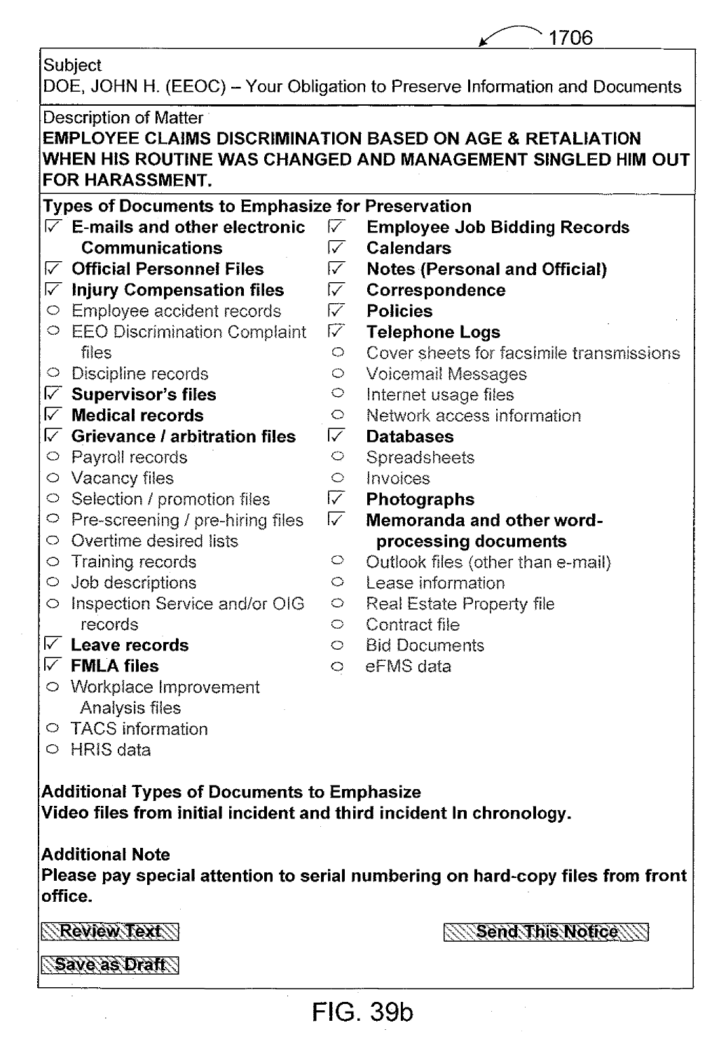

FIGS. 39a and 39b are screenshots illustrating embodiments of interfaces generated by the hold administrator interface module 108. FIG. 39a illustrates the recipient input interface 401, FIG. 39b illustrates the litigation hold input interface 1706. In one embodiment, the recipient input interface 401 may be combined on a single interface with the litigation hold input interface 1706. The litigation hold notice interface 2816 includes an option to return to the list of saved litigation hold notices, to review a litigation hold notice, and to modify options for new notices. In one embodiment, the administrator can modify the default notice for the particular litigation. In another embodiment, the administrator can modify the default notice for all litigations. For example, the user could change the default contact attorney. The database from which the information is taken from, such as the litigation management system could also be changed.

Referring back to FIG. 38, the report interface 3402 may also allow an administrator to determine whether a reminder notice has been sent. The report interface 3402 can also be used to track the date the latest reminder notice was sent. The send hold reminder option 3806 allows an administrator to periodically send a reminder notice to remind the recipients of litigation hold notice that their litigation hold obligations continue. In one embodiment, the hold administrator interface module 108 generates an interface that allows an administrator to send a reminder notice to recipients of a litigation hold notice that have not responded. In one embodiment, the reminder notice contains a link to a preservation and disclosure form. In another embodiment the reminder does not include a link to the preserve and disclosure form because it is not intended as a follow-up message to recipients who have not responded to the notice. For example, the follow up could instead be done by forwarding the initial hold notice email back the recipient.

The reminder notices may be automated by the hold master control module 110. In one embodiment, the hold administrator interface module 108 allows an administrator to put in an amount of time between reminder notices such that a reminder notice is sent periodically, such as each month, to remind recipients of the litigation hold notice of their ongoing obligations. In another embodiment, an administrator can enter a specific date or time period that a reminder notice should be automatically sent if a response is not received.

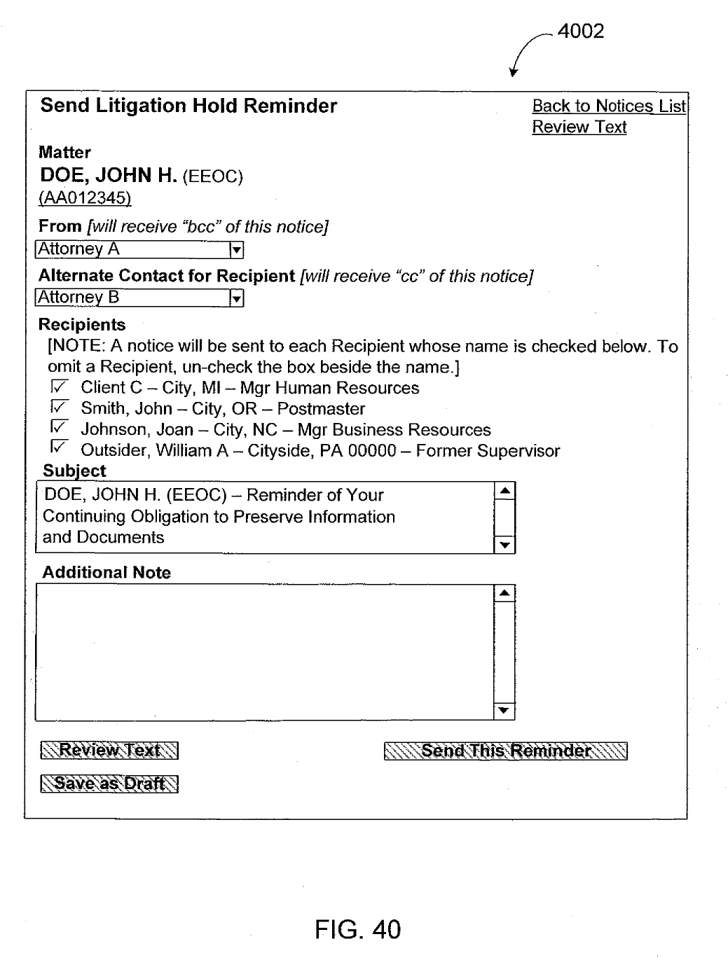

FIG. 40 is a screenshot illustrating one embodiment of a reminder notice input interface 4002 for generating a litigation hold reminder generated by the hold administrator interface module 108. The reminder notice input interface 4002 may contain a list of all the recipients of the original hold notice. The reminder notice input interface 4002 may also include the subject line and additional comments from the original hold notice. The reminder notice input interface 4002 may include options to review, save as a draft, and to send. In one embodiment, the reminder notice automatically appends the message regarding which materials to preserve and other information about the litigation hold from the original notice. The reminder may have text from the original hold notice appended to it. In another embodiment, a reminder notice is sent to an administrator. The system may generate an automatic reminder to the hold administrator periodically or upon certain deadlines or events. These reminders may be automatically generated based on a lack or response by recipients.

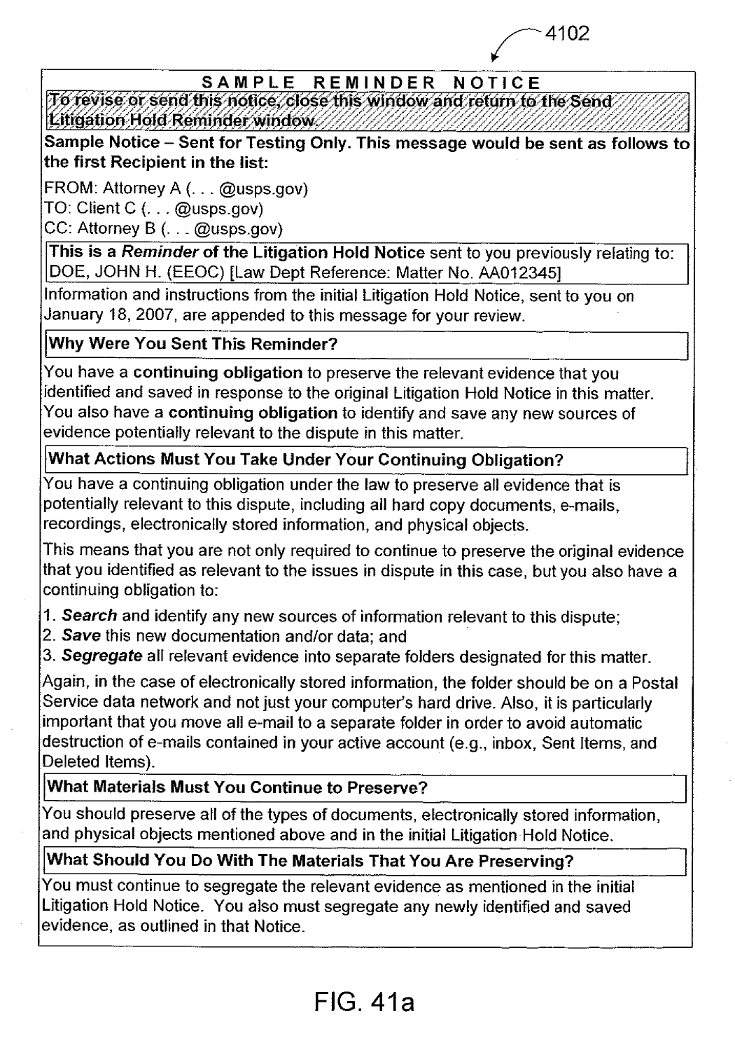

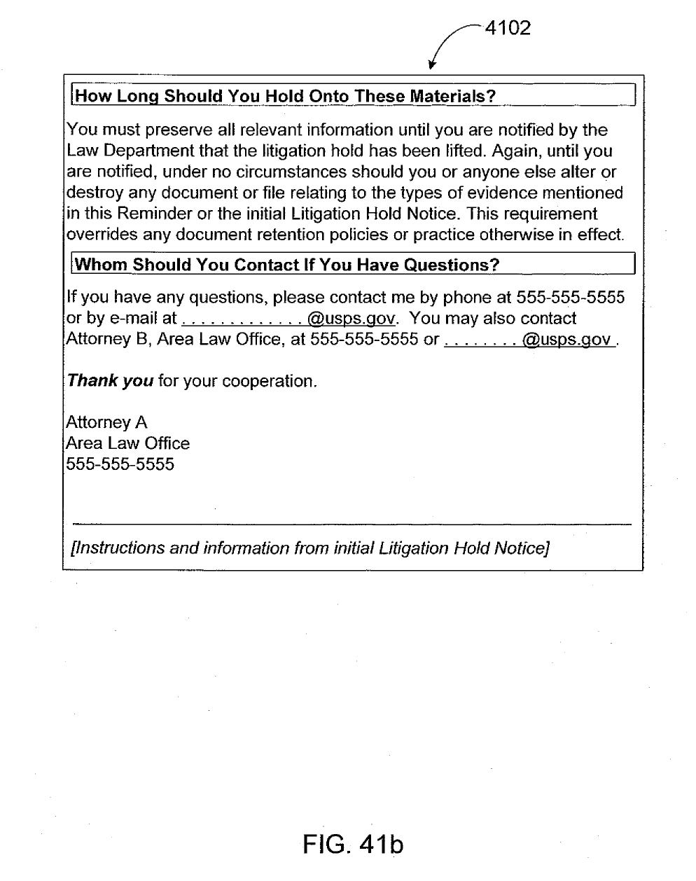

FIGS. 41a and 41b are screenshots illustrating embodiments of a sample litigation hold reminder notice 4102. In one embodiment, the sample litigation hold reminder notice 4102 shown in FIG. 41a can be combined into a single interface with the interface shown in FIG. 41b. The sample litigation hold reminder notice may be generated by the hold administrator interface module 108. The sample litigation hold reminder notice may be generated by the hold administrator interface module 108 so that an administrator may review the reminder notice prior to sending it.

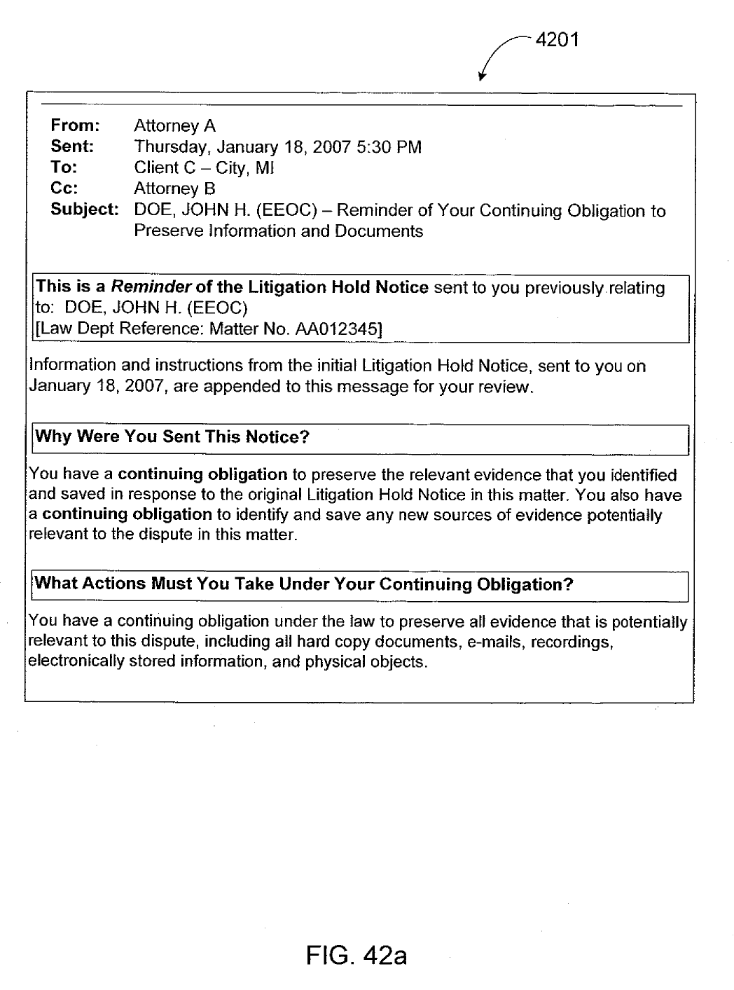

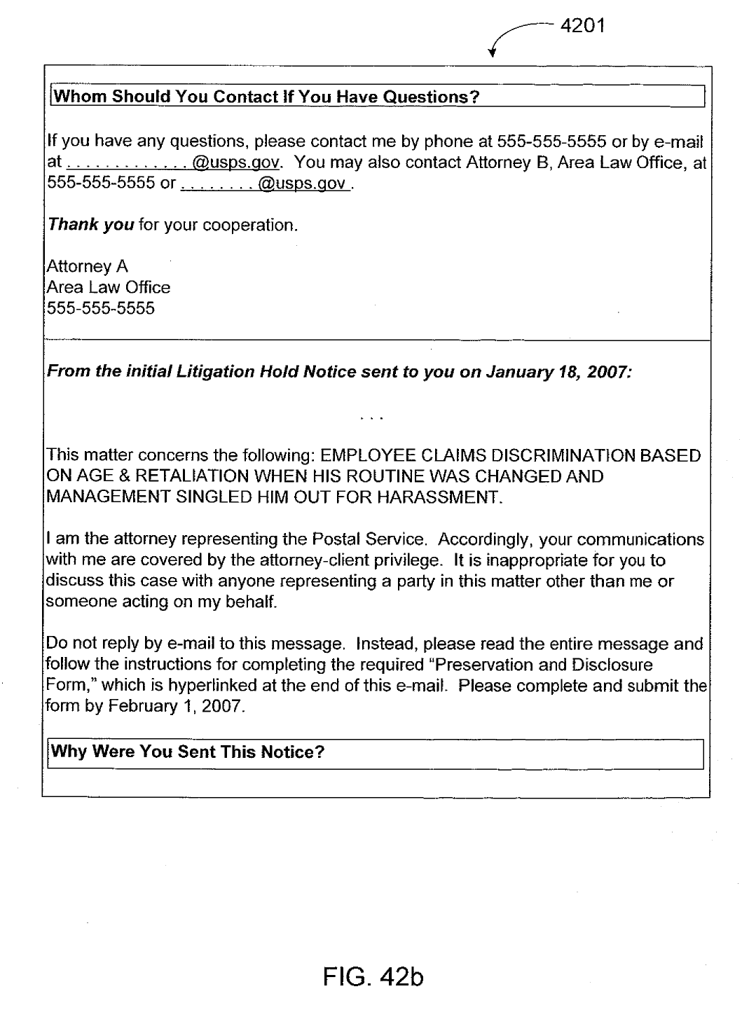

FIGS. 42a and 42b are screenshots illustrating embodiments of a reminder hold notice 4201 generated by the recipient interface module 106. In one embodiment, the reminder hold notice 4201 may contain information from the initial hold notice.

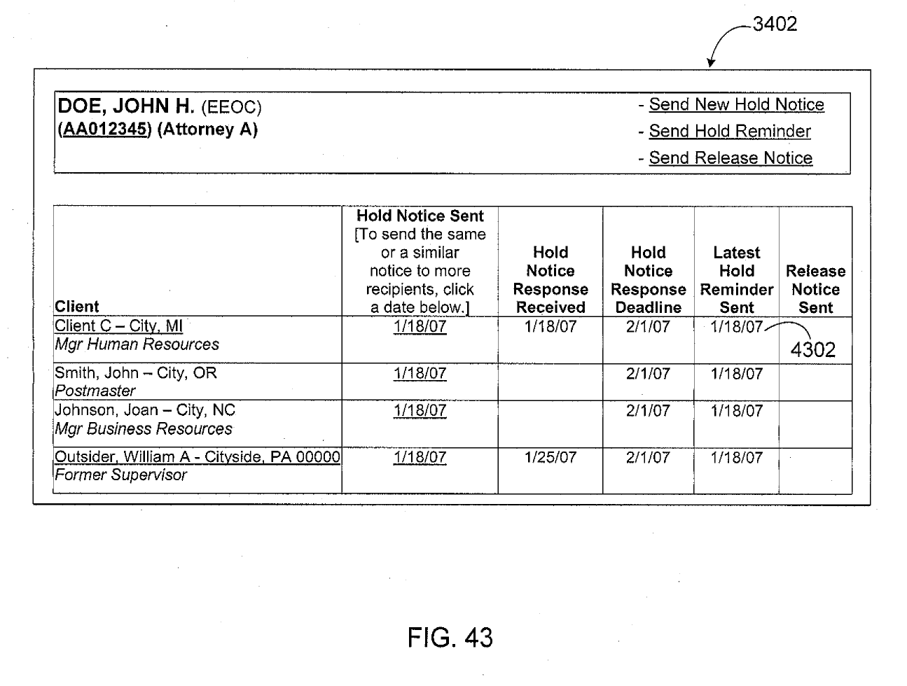

FIG. 43 is a screenshot illustrating another embodiment of the report interface 3402. The date that a reminder notice is sent may be stored in the database 102. When the hold administrator interface module 108 generates a report interface 3402, it may list the date of the last reminder. For example, reminder date 4302 displays the date the last hold reminder was sent to the particular recipient of the litigation hold notice. In another embodiment, the report interface 3402 shows all dates that a reminder notice was sent to the particular recipient.

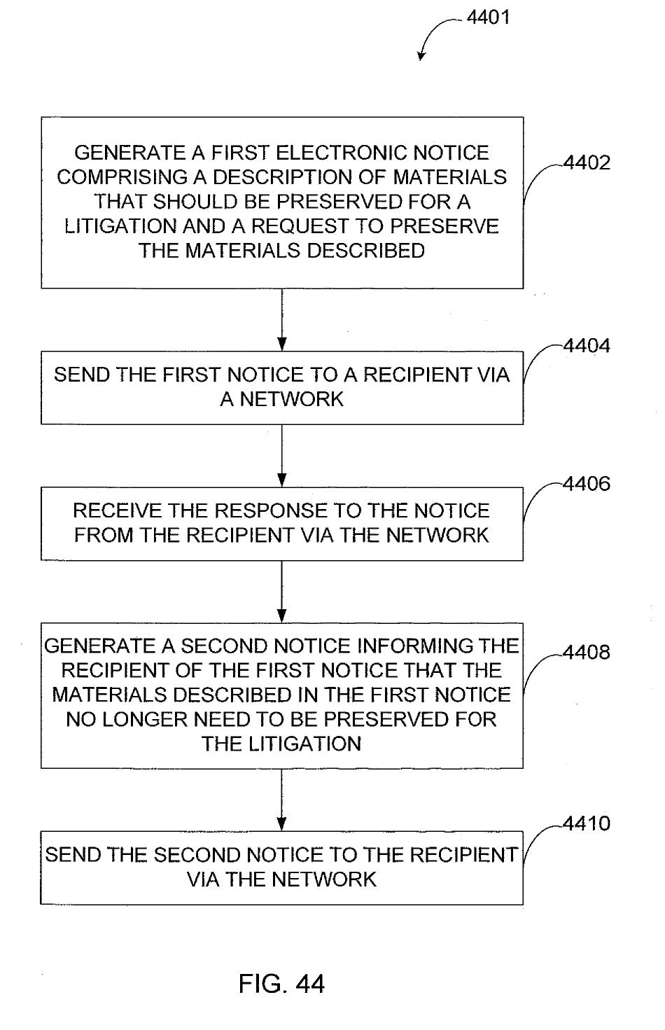

FIG. 44 is a flow diagram illustrating one embodiment of a method 4401 for tracking a litigation hold notice. Beginning at a block 4402, the hold master control module 110 generates a first electronic notice comprising a description of materials that should be preserved for a litigation and generates a request to preserve the materials described. In one embodiment, the electronic notice is the litigation hold notice and the preservation disclosure form described above in relation to FIG. 3. In one embodiment, the electronic notice may be designed in the same manner as described above relating to the block 302 of FIG. 3. In one embodiment, the litigation hold notice and preservation and disclosure form may include the same information as described above in the discussion about the user interface generated at the block 304 of the method 301 described in FIG. 3. Continuing to a block 4404, the hold master control module 110 sends the first notice to a recipient via a network. In one embodiment, the network is the network 104. The recipient interface module 106 may then generate an interface allowing the recipient to respond.

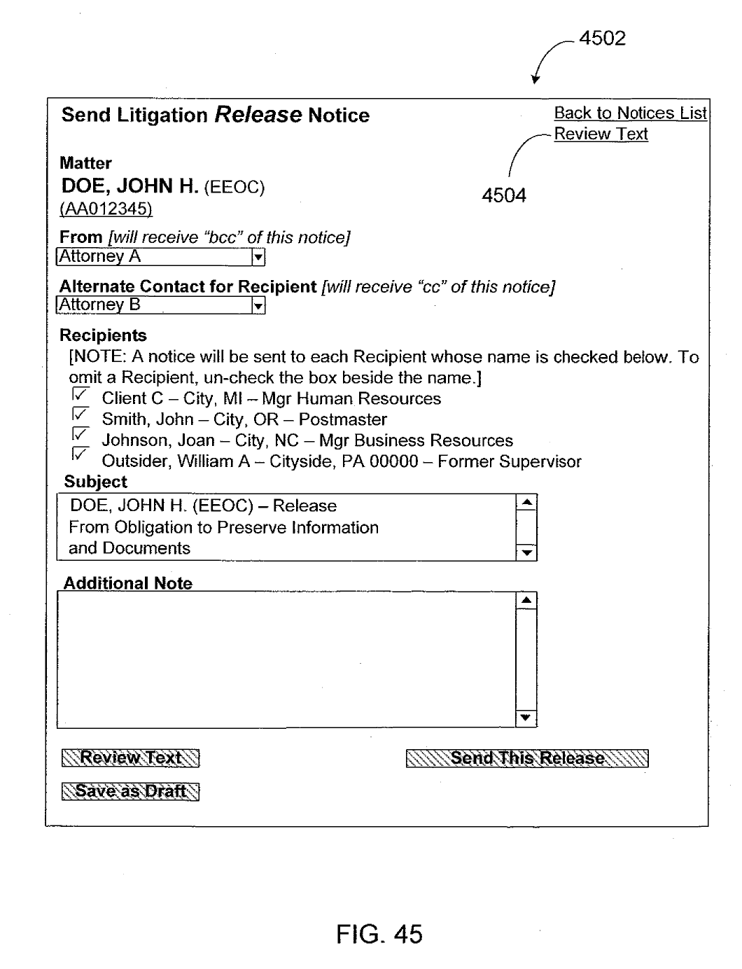

Moving to a block 4406, the hold master control module 110 receives the response to the notice from the recipient via the network. Proceeding to a block 4408, the hold master control module 110 generates a second notice informing the recipient of the first notice that the materials described in the first notice no longer need to be preserved for the litigation. In one embodiment this is referred to as a release notice because it releases the recipient of the litigation hold notice from the obligation stated in the litigation hold notice. Continuing to a block 4410, the hold master control module 110 sends the second notice to the recipient via the network. As shown in FIG. 38, option 3808 allows an administrator to send a release notice. FIGS. 45-47 illustrate in more detail the actions performed at the blocks 4408 and 4410.

FIG. 45 is a screenshot illustrating one embodiment of a release notice input interface 4502 generated by the hold administrator interface module 108. The hold administrator interface module 108 may include information from the database 102 in the release notice input interface 4502.

The release notice input interface 4502 allows an administrator to select recipients for the release notice. In one embodiment, the release notice input interface 4502 displays the recipients of the release notice so that the administrator can add to the list of recipients or delete recipients from the list or recipients. In one embodiment, recipients may be added to the release notice recipient list in a similar manner to the way recipients are added to the litigation hold notice recipient list 410. In one embodiment, the release notice input interface 4502 displays the recipients of the litigation hold notice as the default recipients of the release notice. The administrator may then add additional recipients or remove the recipients of the litigation hold notice.

The release notice input interface 4502 may include any suitable input fields. In one embodiment, the release notice input interface 4502 includes fields similar to the litigation hold notice input interface 1706. For example, the release notice input interface 4502 may initially include information from the litigation hold notice, such as the subject matter and additional note from the litigation hold notice. The administrator can then edit the subject matter and additional note if desired. In one embodiment, the release notice input interface 4502 includes options to review the text, to save the release notice as a draft, and to send the release notice. The release notice input interface 4502 may allow an administrator to enter contact information. In one embodiment the information provided to the release notice input interface 4502 is stored in the database 102. The information input into the release notice input interface 4502 may be stored to the database 102.

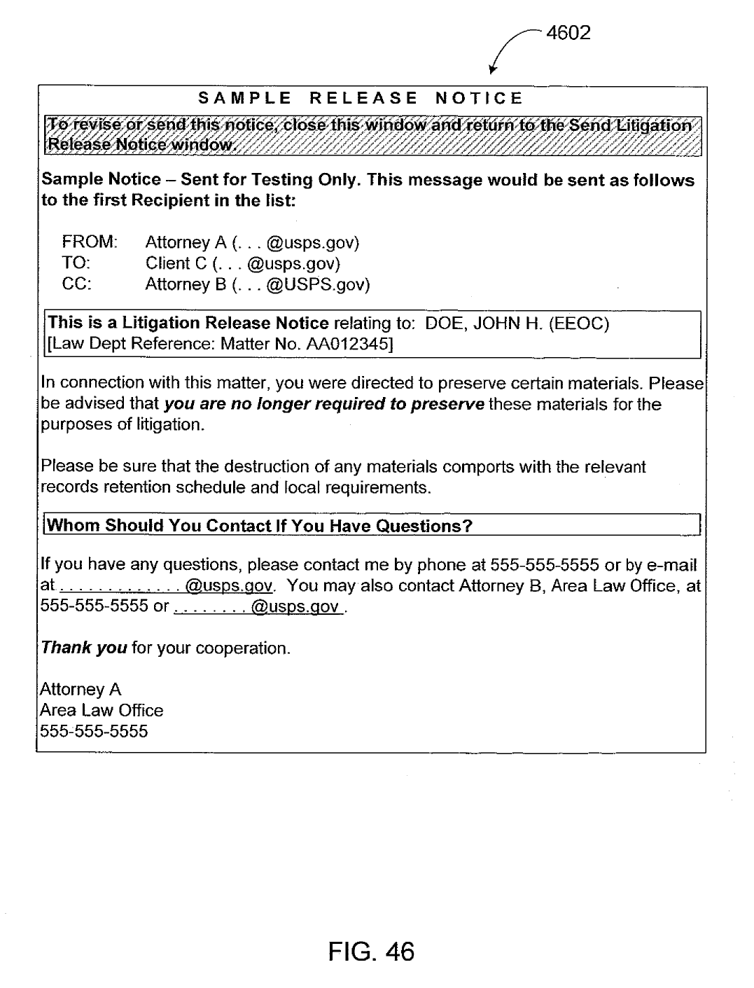

FIG. 46 is a screenshot illustrating one embodiment of a sample release notice interface 4602 generated by the hold administrator interface module 108. The sample release notice interface 4602 may be generated, for example, when an administrator chooses a review text option 4504 from the release notice input interface 4502 shown in FIG. 45. The sample release notice interface 4602 allows an administrator to review the release notice before sending it.

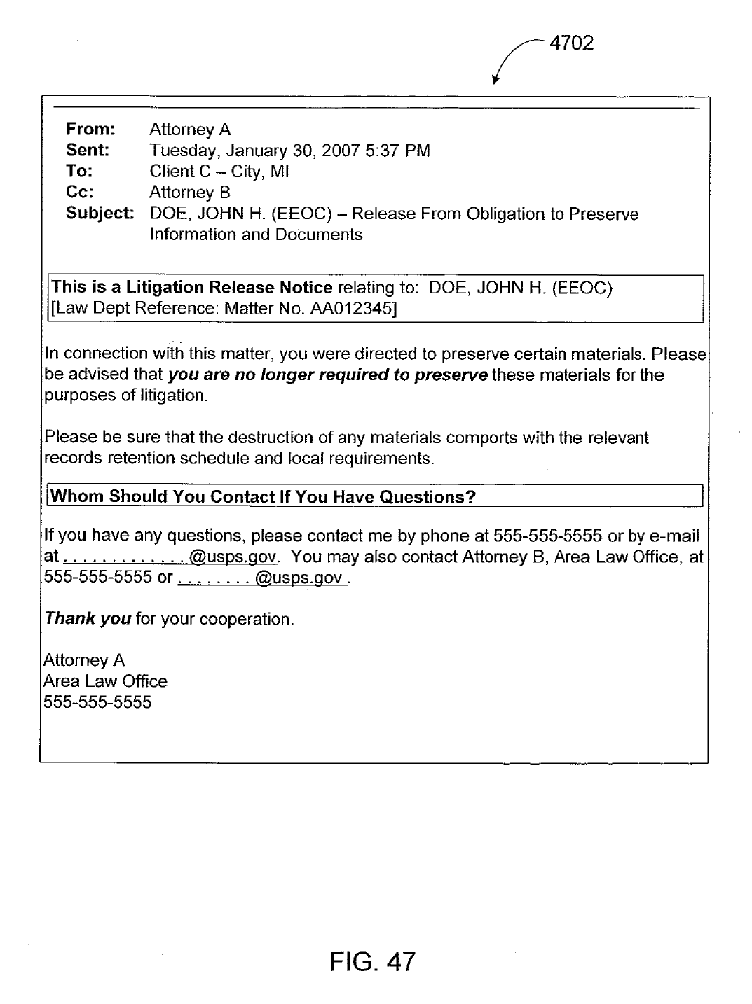

FIG. 47 is a screenshot illustrating one embodiment of a litigation hold release notice. When an administrator sends the release notice, the hold master control module 110 sends the release notice to the recipients selected from the release notice input interface 4502. In one embodiment, the litigation hold release notice is generated by the recipient interface module 106. In one embodiment, the release notice is an email. In one embodiment, the release notice contains information input into release notice input interface 4502. The information is sent from the database 102 to the recipient interface module 106. Once the notice has been sent, the date will be stored in the database 102. The report shown in FIG. 35 can then be shown with the column for the release notice date sent.

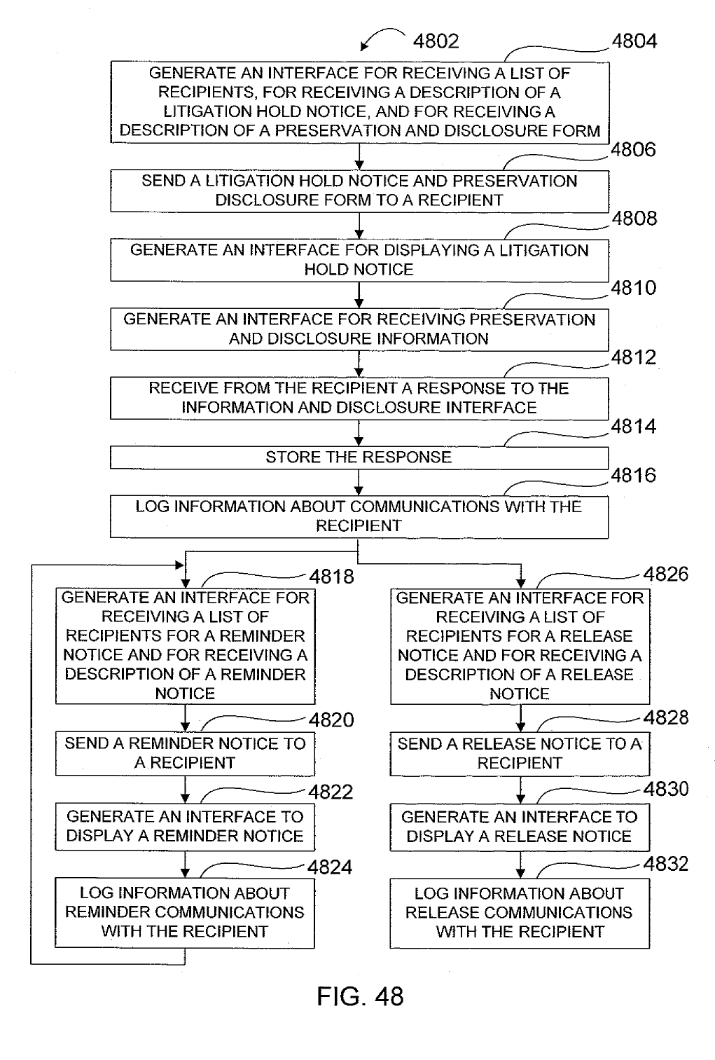

FIG. 48 is a flow diagram illustrating one embodiment of a method 4802 for tracking a litigation hold notice. Beginning at a block 4804, the hold administrator interface module 108 generates an interface for receiving a list of recipients, for receiving a description of a litigation hold notice, and for receiving a description of a preservation and disclosure form. In one embodiment, the interface does not receive a description of a preservation and disclosure form. Continuing to a block 4806, the hold master control module 110 sends a litigation hold notice and preservation and disclosure form to a recipient. In one embodiment, the recipient was entered into the interface for receiving a list of recipients. Moving to a block 4808, the recipient interface module 106 generates an interface for displaying a litigation hold notice. Proceeding to a block 4810, the recipient interface module 106 generates an interface for receiving preservation and disclosure information. Continuing to a block 4812, the hold master control module 110 receives from the recipient a response to the information and disclosure interface. Moving to a block 4814, the hold master control module 110 stores the recipient's response in the database 102. Next at a block 4816, the hold master control module 110 logs information about communications with the recipient to the database 102. In one embodiment, the hold administrator interface module 108 displays information about communications with the recipient.

In one embodiment, an administrator may then send a reminder notice. At a block 4818, the hold administrator interface module 108 generates an interface for receiving a list of recipients for a reminder notice and for receiving a description of a reminder notice. Continuing to a block 4820, the hold master control module 110 sends a reminder notice to a recipient. Moving to a block 4822, the recipient interface module 106 generates an interface to display a reminder notice. Continuing to a block 4824, the hold master control module 110 logs information about reminder communications with the recipient. In one embodiment, the hold administrator interface module 108 then generates an interface displaying information about reminder communications with the recipient.

In one embodiment, an administrator may send a release notice once a litigation hold obligation has ended. Moving to a block 4826, the hold administrator interface module 108 generates an interface for receiving a list of recipients for a release notice and for receiving a description of a release notice. Continuing to a block 4828, the hold master control module 110 sends a release notice to a recipient. Moving to a block 4830, the recipient interface module 106 generates an interface to display a release notice to a recipient. Proceeding to a block 4832, the hold master control module 110 logs information about release communications with the recipient. In one embodiment, the hold administrator interface module 108 then generates an interface displaying information about release communications with the recipient.

Figures depicting screenshots are provided for illustrative purposes only. A litigation hold system may include interfaces that appear different than those shown herein. The interfaces may also include fields in addition to those described in the figures. As is to be recognized, the interface fields discussed herein are provided as examples, and the interfaces described herein are not required to include all of the specific fields discussed in order to achieve the desired functionality. The interfaces shown in the figures may also be combined or divided in any suitable manner.

In view of the above, one will appreciate that the developed embodiments overcome the problem of efficiently tracking litigation hold notices. For example, embodiments allow for efficient systems and methods for efficiently designing and sending litigation hold notices and litigation hold release notices. Furthermore, embodiments allow for efficient systems and methods for tracking responses to a litigation hold notice.

Those of skill will recognize that the various illustrative logical blocks and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present development.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. An interface described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

While the above detailed description has shown, described, and pointed out novel features of the development as applied to various embodiments, it will be understood that various omissions, substitutions, and changes in the form and details of the device or process illustrated may be made by those skilled in the art without departing from the spirit of the development. As will be recognized, the present development may be embodied within a form that does not provide all of the features and benefits set forth herein, as some features may be used or practiced separately from others. The scope of the development is indicated by the appended claims rather than by the foregoing description. All changes which come within the meaning and range of equivalency of the claims are to be embraced within their scope.

What is claimed is:

1. A method of tracking materials preserved for a litigation comprising:
providing a user interface for receiving a description of materials that should be preserved for a litigation and data identifying at least one recipient of an electronic notice regarding the litigation;
generating a user interface for requesting information from the recipient, wherein the requested information comprises:
a certification that the recipient is in possession of materials that should be preserved for the litigation;
a description of the recipient's procedures for preserving the materials that should be preserved for the litigation; and
a list of other entities identified by the recipient as associated with materials to be preserved for the litigation;
receiving via a network a response from the recipient;
storing the response; and
logging information about communications with the recipient.

2. The method of claim 1, wherein an entity is a person.

3. The method of claim 1, wherein information about communications comprises:
the date the recipient received the electronic notice;
the date the response was received from the recipient; and
a deadline for receiving a response from the recipient.

4. The method of claim 1, wherein a plurality of user interfaces for receiving a description of materials are provided for the litigation.

5. The method of claim 1, wherein a plurality of user interfaces for requesting information from the recipient are generated for the litigation.

6. The method of claim 1, further comprising emailing the response received from the recipient to a designated person.

7. The method of claim 1, wherein the recipient may be inside or outside of an organization.

8. The method of claim 1, wherein the data identifying at least one recipient of an electronic notice is data identifying a group of recipients.

9. The method of claim 1, further comprising providing an interface for displaying information about communications with the recipient.

10. The method of claim 9, further comprising displaying a link to the response received from the recipient.

11. The method of claim 1, further comprising generating an electronic reminder notice and sending it to the recipient if a response is not received from the recipient by a deadline.

12. The method of claim 1, wherein a recipient may forward the user interface requesting information to another recipient.

13. A method of tracking materials preserved for litigation comprising:
generating a first electronic notice comprising a description of materials that should be preserved for a litigation and a request to preserve the materials described;
sending the first notice to a recipient via a network;
receiving a response to the notice from the recipient via the network;
generating a second notice informing the recipient of the first notice that the materials described in the first notice no longer need to be preserved for the litigation; and
sending the second notice to the recipient via the network.

14. The method of claim 13, further comprising logging information about selected communications with the recipient.

15. The method of claim 14, wherein information about selected communications comprises:
the date the first notice was sent to the recipient;
the date the response was received from the recipient; and
the date the second notice was sent to the recipient.

16. The method of claim 14, further comprising providing a user interface for displaying information about selected communications with the recipient.

17. The method of claim 13, wherein the first notice is sent to a plurality of recipients.

18. The method of claim 17, further comprising generating a list of recipients of the second notice based at least in part on the plurality of recipients that received the first notice.

19. A system for tracking materials preserved for a litigation comprising:
a storage medium configured to store information regarding communications with a recipient of an electronic notice; and
at least one processor configured to:
provide a user interface for receiving a description of materials that should be preserved for a litigation and data identifying at least one recipient of an electronic notice regarding the litigation;
generate a user interface for requesting information from the recipient, wherein the requested information comprises:
a certification that the recipient is in possession of materials that should be preserved for the litigation;
a description of the recipient's procedures for preserving the materials that should be preserved for the litigation; and
a list of other entities identified by the recipient as associated with materials to be preserved for the litigation;
receive via a network a response from the recipient;
store the response; and
log information about communications with the recipient.

20. The system of claim 19, wherein the processor is further configured to provide an interface for displaying information about communications with the recipient.

21. The system of claim 19, wherein the processor is further configured to generate an electronic reminder notice and sending it to the recipient if a response is not received from the recipient by a deadline.

22. A system of tracking materials preserved for litigation comprising:
a storage medium configured to store information about communications with a recipient of an electronic notice; and
at least one processor configured to:
generate a first electronic notice comprising a description of materials that should be preserved for a litigation and a request to preserve the materials described;
send the first notice to a recipient via a network;
receive a response to the notice from the recipient via the network;
generate a second notice informing the recipient of the first notice that the materials described in the first notice no longer need to be preserved for the litigation; and
send the second notice to the recipient via the network.

23. The system of claim 22, wherein the processor is further configured to log information about selected communications with the recipient.

24. The system of claim 23, wherein the processor is further configured to provide a user interface for displaying information about selected communications with the recipient.

25. The system of claim 22, wherein the first notice is sent to a plurality of recipients.

26. The system of claim 25, wherein the processor is further configured to generate a list of recipients of the second notice based at least in part on the plurality of recipients that received the first notice.

27. A system for tracking materials preserved for a litigation comprising:
means for providing a user interface for receiving a description of materials that should be preserved for a litigation and data identifying at least one recipient of an electronic notice regarding the litigation;
means for generating a user interface for requesting information from the recipient, wherein the requested information comprises:
a certification that the recipient is in possession of materials that should be preserved for the litigation;
a description of the recipient's procedures for preserving the materials that should be preserved for the litigation; and
a list of other entities identified by the recipient as associated with materials to be preserved for the litigation;
means for receiving via a network a response from the recipient;
means for storing the response; and
means for logging information about communications with the recipient.

28. The system of claim 27, further comprising means for providing an interface for displaying information about communications with the recipient.

29. The system of claim 27, further comprising means for generating an electronic reminder notice and sending it to the recipient if a response is not received from the recipient by a deadline.

30. A system of tracking materials preserved for litigation comprising:
means for generating a first electronic notice comprising a description of materials that should be preserved for a litigation and a request to preserve the materials described;
means for sending the first notice to a recipient via a network;
means for receiving a response to the notice from the recipient via the network;
means for generating a second notice informing the recipient of the first notice that the materials described in the first notice no longer need to be preserved for the litigation; and
means for sending the second notice to the recipient via the network.

31. The system of claim 30, wherein further comprising means for logging information about selected communications with the recipient.

32. The system of claim 31, wherein further comprising means for providing a user interface for displaying information about selected communications with the recipient.

33. The system of claim 30, wherein the first notice is sent to a plurality of recipients.

34. The system of claim 33, further comprising means for generating a list of recipients of the second notice based at least in part on the plurality of recipients that received the first notice.
